(19) United States
(12) Patent Application Publication
(10) Pub. No.: US 2007/0221884 A1
(43) Pub. Date: Sep. 27, 2007

(54) Liminescent Silicon Oxide Flakes

(76) Inventors: Holger Hoppe, Lorrach (DE); Patrice Bujard, Courtepin (CH); Martin Muller, Lorrach (DE); Hans Reichert, Rheinfelden (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/631,446

(22) PCT Filed: Jul. 6, 2005
(86) PCT No.: PCT/EP05/53214

§ 371 Date: Jan. 3, 2007

(30) Foreign Application Priority Data
Jul. 16, 2004 (EP) 04103-409.1

(51) Int. Cl. C09K 11/06; C09K 11/08

(52) U.S. Cl. 252/301.28; 252/301.16; 252/301.4 P; 252/301.4 S; 252/301.5; 252/301.6 S

(57) ABSTRACT

The present invention relates to luminescent SiO_{z}, flakes, especially porous luminescent SiO_{z} flakes, wherein 0.70≦z≦2.0, especially 0.95≦z≦2.0, comprising an organic, or inorganic luminescent compound, or composition, which can provide enhanced (long term) luminescent efficacy.

The present invention relates to luminescent SiO_{z} flakes, especially luminescent porous SiO_{z} flakes, wherein 0.70≦z≦2.0, especially 0.95≦z≦2.0, comprising an organic, or inorganic luminescent compound, or composition, which can provide enhanced (long term) luminescent efficacy.

It is the object of the present invention to provide luminescent SiO_{z} particles having high luminescent efficacy.

Said object has been solved by luminescent SiO_{z} flakes, especially luminescent porous SiO_{z} flakes, wherein 0.70≦z≦2.0, especially 0.95≦z≦2.0, very especially 1.40≦z≦2.0, comprising an organic, or inorganic luminescent compound, or composition.

The term “SiO_{z} with 0.70≦z≦2.0” means that the molar ratio of oxygen to silicon at the average value of the silicon oxide substrate is from 0.70 to 2.0. The composition of the silicon oxide substrate can be determined by ESCA (electron spectroscopy for chemical analysis). The stoichiometry of silicon and oxygen of the silicon oxide substrate can be determined by RBS (Rutherford-Backscattering).

According to the present invention the term “SiO_{z} flakes comprising a luminescent compound, or composition” includes that the (whole) surface of the (porous) SiO_{z} flakes is covered by the luminescent compound, or composition, that the pores or parts of the pores of the porous SiO_{z} flakes are filled with the luminescent compound, or composition, and/or that the (porous) SiO_{z} flakes are coated at individual points with the luminescent compound, or composition. In one preferred embodiment, the pores or parts of the pores of the porous SiO_{z} flakes are filled with the luminescent compound, or composition. As the size of the pores of the SiO_{z} flakes can be controlled by the process for the production of the porous SiO_{z} flakes to be in the range of from ca. 1 to ca. 50 nm, especially ca. 2 to ca. 20 nm, it is, for example, possible to create nanosized luminescent particles within the pores of SiO_{z} flakes.

The plate-like (plane-parallel) SiO_{z} structures (SiO_{z} flakes), especially porous SiO_{z} flakes used according to the present invention have a length of from 1 μm to 5 mm, a width of from 1 μm to 2 mm, and a thickness of from 20 nm to 1.5 μm, and a ratio of length to thickness of at least 2:1, the particles having two substantially parallel faces, the distance between which is the shortest axis of the particles. The porous SiO_{z} flakes are mesoporous materials, i.e. have pore widths of ca. 1 to ca. 50 nm, especially 2 to 20 nm. The pores are randomly inter-connected in a three-dimensional way. So, when used as a support, the passage blockage, which frequently occurs in SiO₂ flakes having a two-dimensional arrangement of pores can be prevented. The specific surface area of the SiO_{z} flakes depends on the porosity and ranges from ca. 400 m²/g to more than 1000 m²/g. Preferably, the porous SiO_{z} flakes have a specific surface area of greater than 500 m²/g, especially greater than 600 m²/g. The BET specific surface area is determined according to DIN 66131 or DIN 66132 (R. Haul und G. Dümbgen, Chem.-Ing.-Techn. 32 (1960) 349 and 35 (1063) 586) using the Brunauer-Emmet-Teller method (J. Am. Chem. Soc. 60 (1938) 309).

The SiO_{z} flakes, especially porous SiO_{z} flakes are not of a uniform shape. Nevertheless, for purposes of brevity, the flakes will be referred to as having a “diameter.” The SiO_{z} flakes have a plane-parallelism and a defined thickness in the range of ±10%, especially ±5% of the average thickness. The SiO_{z} flakes have a thickness of from 20 to 2000 nm, especially from 100 to 500 nm. It is presently preferred that the diameter of the flakes is in a preferred range of about 1-60 μm with a more preferred range of about 5-40 μm and a most preferred range of about 5-20 μm. Thus, the aspect ratio of the flakes of the present invention is in a preferred range of about 2.5 to 625 with a more preferred range of about 50 to 250.

The present invention is illustrated in more detail on the basis of the porous SiO_{z} flakes, but not limited thereto. Non-porous SiO_{z} flakes, which can be prepared according to a process described in WO04/035693, are also suitable.

The porous SiO_{z} flakes are obtainable by a process described in WO04/065295. Said process comprises the steps of:
a) vapor-deposition of a separating agent onto a carrier to produce a separating agent layer,
b) the simultaneous vapor-deposition of SiO_{y} and a separating agent onto the separating agent layer (a),
c) the separation of SiO_{y} from the separating agent, wherein 0.70≦y≦1.80.

If in the above process step a) is omitted and the carrier is replaced by a substrate material, a substrate material comprising a porous SiO_{z} film can be prepared, which subsequently can be treated with a luminescent organic or inorganic compound, or composition as described below. [Composition]

The platelike material can be produced in a variety of distinctable and reproducible variants by changing only two process parameters: the thickness of the mixed layer of SiO_{y} and separating agent and the amount of the SiO_{y} contained in the mixed layer.

The term “SiO_{y} with 0.70≦y≦1.80” means that the molar ratio of oxygen to silicon at the average value of the silicon oxide layer is from 0.70 to 1.80. The composition of the silicon oxide layer can be determined by ESCA (electron spectroscopy for chemical analysis). The stoichiometry of silicon and oxygen of the silicon oxide layer can be determined by RBS (Rutherford-Backscattering).

The separating agent vapor-deposited onto the carrier in step a) may be a lacquer (surface coating), a polymer, such as, for example, the (thermoplastic) polymers, in particular acryl- or styrene polymers or mixtures thereof, as described in U.S. Pat. No. 6,398,999, an organic substance soluble in organic solvents or water and vaporisable in vacuo (see, for example, WO021094945 and EP04104041.1), such as anthracene, anthraquinone, acetamidophenol, acetylsalicylic acid, camphoric anhydride, benzimidazole, benzene-1,2,4-tricarboxylic acid, biphenyl-2,2-dicarboxylic acid, bis(4-hydroxyphenyl)sulfone, dihydroxyanthraquinone, hydantoin, 3-hydroxybenzoic acid, 8-hydroxyquinoline-5-sulfonic acid monohydrate, 4-hydroxycoumarin, 7-hydroxycoumarin, 3-hydroxynaphthalene-2-carboxylic acid, isophthalic acid, 4,4-methylene-bis-3-hydroxynaphthalene-2-carboxylic acid, naphthalene-1,8-dicarboxylic anhydride, phthalimide and its potassium salt, phenolphthalein, phenothiazine, saccharin and its salts, tetraphenylmethane, triphenylene, triphenylmethanol or a mixture of at least two of those substances, or an inorganic salt soluble in water and vaporisable in vacuo (see, for example, DE 198 44 357), such as sodium chloride, potassium chloride, lithium chloride, sodium fluoride, potassium fluoride, lithium fluoride, calcium fluoride, sodium aluminium fluoride and disodium tetraborate.

In detail, a salt, for example NaCl, followed successively by a layer of silicon suboxide (SiO_{y}) and separating agent, especially NaCl or an organic separating agent, is vapor-deposited onto a carrier, which may be a continuous metal belt, passing by way of the vaporisers under a vacuum of <0.5 Pa.

The mixed layer of silicon suboxide (SiO_{y}) and separating agent is vapor-deposited by two distinct vaporizers, which are each charged with one of the two materials and whose vapor beams overlap, wherein the separating agent is contained in the mixed layer in an amount of 1 to 60% by weight based on the total weight of the mixed layer.

The thicknesses of salt vapor-deposited are about 20 nm to 100 nm, especially 30 to 60 nm, those of the mixed layer from 20 to 2000 nm, especially 50 to 500 nm depending upon the intended characteristics of the product.

The carrier is immersed in a dissolution bath (water). With mechanical assistance, the separating agent (NaCl) layer rapidly dissolves and the product layer breaks up into flakes, which are then present in the solvent in the form of a suspension. The porous silicon oxide flakes can advantageously be produced using an apparatus described in U.S. Pat. No. 6,270,840.

The suspension then present in both cases, comprising product structures and solvent, and the separating agent dissolved therein, is then separated in a further operation in accordance with a known technique. For that purpose, the product structures are first concentrated in the liquid and rinsed several times with fresh solvent in order to wash out the dissolved separating agent. The product, in the form of a solid that is still wet, is then separated off by filtration, sedimentation, centrifugation, decanting or evaporation.

A SiO_{1.00-1.8} layer is formed preferably from silicon monoxide vapour produced in the vaporiser by reaction of a mixture of Si and SiO₂ at temperatures of more than 1300° C.

A SiO_{0.70-0.99} layer is formed preferably by evaporating silicon monoxide containing silicon in an amount up to 20% by weight at temperatures of more than 1300° C.

The production of porous SiO_{z} flakes with z>1 can be achieved by providing additional oxygen during the evaporation. For this purpose the vacuum chamber can be provided with a gas inlet, by which the oxygen partial pressure in the vacuum chamber can be controlled to a constant value.

Alternatively, after drying, the product can be subjected to oxidative heat treatment. Known methods are available for that purpose. Air or some other oxygen-containing gas is passed through the plane-parallel structures of SiO_{y} wherein y is, depending on the vapor-deposition conditions, from 0.70, especially 1 to about 1.8, which are in the form of loose material or in a fluidised bed, at a temperature of more than 200° C., preferably more than 400° C. and especially from 500 to 1000° C. After several hours all the structures will have been oxidised to SiO_{z}. The product can then be brought to the desired particle size by means of grinding or air-sieving, wherein comminution of the fragments of film to pigment size can be effected, for example, by means of ultrasound or by mechanical means using high-speed stirrers in a liquid medium, or after drying the fragments in an air-jet mill having a rotary classifer.

Alternatively, after drying, the porous SiO_{y} particles can be heated according to WO03/106569 in an oxygen-free atmosphere, i.e. an argon or helium atmosphere, or in a vacuum of less than 13 Pa (10⁻¹ Torr), at a temperature above 400° C., especially 400 to 1100° C., whereby porous silicon oxide flakes containing Si nanoparticles can be obtained.

It is assumed that by heating SiO_{y} particles in an oxygen-free atmosphere, SiO_{y} disproportionates in SiO₂ and Si:
SiO_{y}→(y/y+a)SiO_{y+a}+(1−y/y+a)Si

In this disproportion porous SiO_{y+a} flakes are formed, containing (1−(y/y+a))Si, wherein 0.70≦y≦1.8, especially 0.70≦y≦0.99 or 1≦y≦1.8, 0.05≦a≦1.30, and the sum y and a is equal or less than 2. SiO_{y+a} is an oxygen enriched silicon suboxide.
SiO_{y}→(y/2)SiO₂+(1−(y/2))Si

The porous SiO_{z} flakes should have a minimum thickness of 50 nm, to be processible. The maximum thickness is dependent on the desired application, but is in general in the range of from 150 to 500 nm. The porosity of the flakes ranges from 5 to 85%.

The term “luminescence” means the emission of light in the visible, UV- and IR-range after input of energy. The luminescent material can be a fluorescent material, a phosphorescent material, an electroluminescent material, a chemoluminescent material, a triboluminescent material, or other like materials. Such luminescent materials exhibit a characteristic emission of electromagnetic energy in response to an energy source generally without any substantial rise in temperature.

In one aspect the present invention is directed to luminescent porous SiO_{z} flakes, comprising an organic luminescent compound, or composition, i.e. a luminescent colorant, wherein the term colorant comprises dyes as well as pigments.

Preferred fluorescent colorants are based on known colorants selected from coumarins, benzocoumarins, xanthenes, benzo[a]xanthenes, benzo[b]xanthenes, benzo[c]xanthenes, phenoxazines, benzo[a]phenoxazines, benzo[b]phenoxazines and benzo[c]phenoxazines, napthalimides, naphtholactams, azlactones, methines, oxazines and thiazines, diketopyrrolopyrroles, perylenes, quinacridones, benzoxanthenes, thio-epindolines, lactamimides, diphenylmaleimides, acetoacetamides, imidazothiazines, benzanthrones, perylenmonoimides, perylenes, phthalimides, benzotriazoles, pyrimidines, pyrazines, triazoles, dibenzofurans and triazines.

Examples of organic fluorescent colorants are:
a) Xanthene colorants of formula 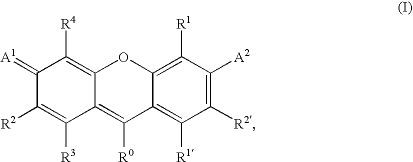
wherein A¹ represents O or N-Z in which Z is H or C₁-C₈alkyl, or is optionally combined with R², or R⁴ to form a 5- or 6-membered ring, or is combined with each of R² and R⁴ to form two fused 6-membered rings; A² represents —OH or —NZ₂; R¹, R^{1′}, R², R^{2′}, R³ and R⁴ are each independently selected from H, halogen, cyano, CF₃, C₁-C₈alkyl, C₁-C₈alkylthio, C₁-C₈alkoxy, aryl and heteroaryl; wherein the alkyl portions of any of R¹, R^{2′} or R¹ through R⁴ are optionally substituted with halogen, carboxy, sulfo, amino, mono- or dialkylamino, alkoxy, cyano, haloacetyl or hydroxy; and the aryl or heteroaryl portions of any of R^{1′}, R^{2′} or R¹ through R⁴ are optionally substituted with from one to four substituents selected from the group consisting of halogen, cyano, carboxy, sulfo, hydroxy, amino, mono- or di(C₁-C₈)alkylamino, C₁-C₈alkyl, C₁-C₈alkylthio and C₁-C₈alkoxy; R⁰ is halogen, cyano, CF₃, C₁-C₈alkyl, C₁-C₈alkenyl, C₁-C₈alkynyl, aryl or heteroaryl having the formula: 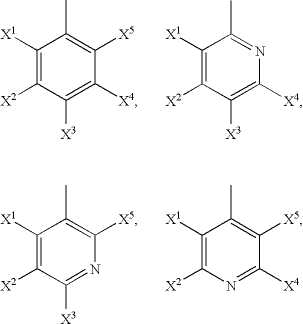
wherein X¹, X², X³, X⁴ and X⁵ are each independently selected from the group consisting of H, halogen, cyano, CF₃, C₁-C₈alkyl, C₁-C₈alkoxy, C₁-C₈alkylthio, C₁-C₈alkenyl, C₁-C₈alkynyl, SO₃H and CO₂H. Additionally, the alkyl portions of any of X¹ through X⁵ can be further substituted with halogen, carboxy, sulfo, amino, mono- or dialkylamino, alkoxy, cyano, haloacetyl or hydroxy. Optionally, any two adjacent substituents X¹ through X⁵ can be taken together to form a fused aromatic ring that is optionally further substituted with from one to four substituents selected from halogen, cyano, carboxy, sulfo, hydroxy, amino, mono- or di(C₁-C₈) alkylamino, (C₁-C₈)alkyl, (C₁-C₈)alkylthio and (C₁-C₈)alkoxy.

In certain embodiments, the xanthene colorants of formula I (as well as other formulae herein) will be present in isomeric or tautomeric forms which are included in this invention.
b) Benzo[a]xanthen colorants of formula 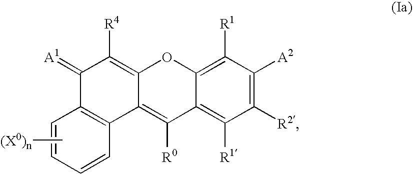
wherein
n is an integer of 0 to 4,
each X⁰ is independently selected from the group consisting of H, halogen, cyano, CF₃, C₁-C₈alkyl, C₁-C₈alkoxy, C₁-C₈alkylthio, C₁-C₈alkenyl, C₁-C₈alkynyl, aryl, heteroaryl, SO₃H and CO₂H;
A¹, A², R⁰, R¹, R^{1′}, R^{2′}, and R⁴ are as defined above, wherein the alkyl portions of X⁰ can be further substituted with halogen, carboxy, sulfo, amino, mono- or dialkylamino, alkoxy, cyano, haloacetyl or hydroxy, and the aryl or heteroaryl portions of any of R¹, R^{1′}, R^{2′}, and R⁴ are optionally substituted with from one to four substituents selected from the group consisting of halogen, cyano, carboxy, sulfo, hydroxy, amino, mono- or di(C₁-C₈)alkylamino, C₁-C₈alkyl, C₁-C₈alkylthio and C₁-C₈alkoxy.
c) Benzo[b]xanthen colorants of formula 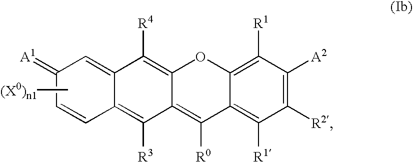
wherein
n1 is an integer of 0 to 3, X⁰, A¹, A², R⁰, R¹, R^{1′}, R^{2′}, R³ and R⁴ are as defined above.
d) Benzo[b]xanthen colorants of formula 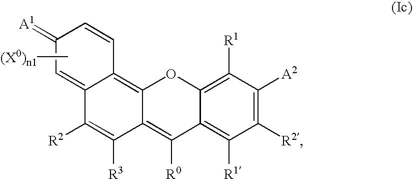
wherein
n1 is an integer of 0 to 3, X⁰, A¹, A², R⁰, R¹, R^{1′}, R^{2′}, R² and R³ are as defined above.

The following xanthene colorants and thioxanthene colorants are particularly preferred: 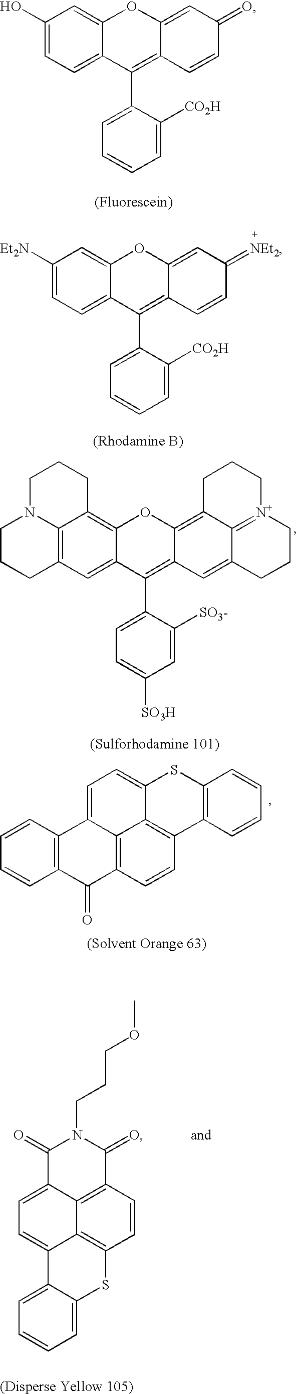 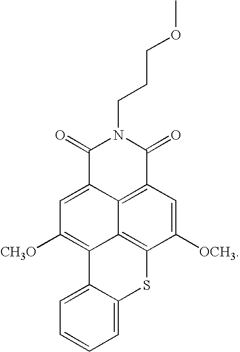
e) Coumarin colorants of formula 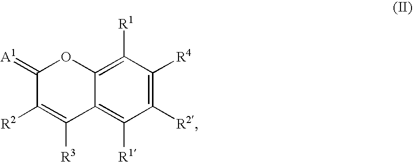
wherein A¹, R¹, R^{1′}, R^{2′}, R², R³, and R⁴ are as defined above. In certain embodiments R² and R³ are independently of each other of halogen, cyano, CF₃, C₁-C₈alkyl, aryl, or heteroaryl having the formula 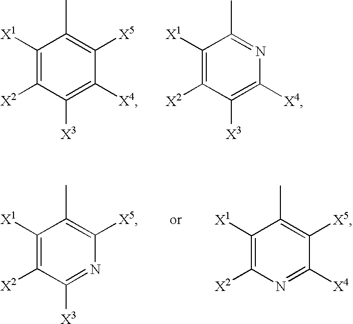
wherein X¹, X², X³, X⁴ and X⁵ are as defined above.

The benzocoumarin series of colorants are those of formula II in which R² and R³ are combined to form a fused benzene ring, optionally substituted with one to four substituents selected from halogen cyano, carboxy, sulfo, hydroxy, amino, mono- or di(C₁-C₈)alkylamino, C₁-C₈alkyl, C₁-C₈alkylthio and C₁-C₈alkoxy.

The following coumarine colorants are particularly preferred: 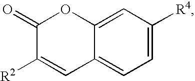
wherein R⁴ is —N(C₂H₅)₂ and R² is a group of formula: 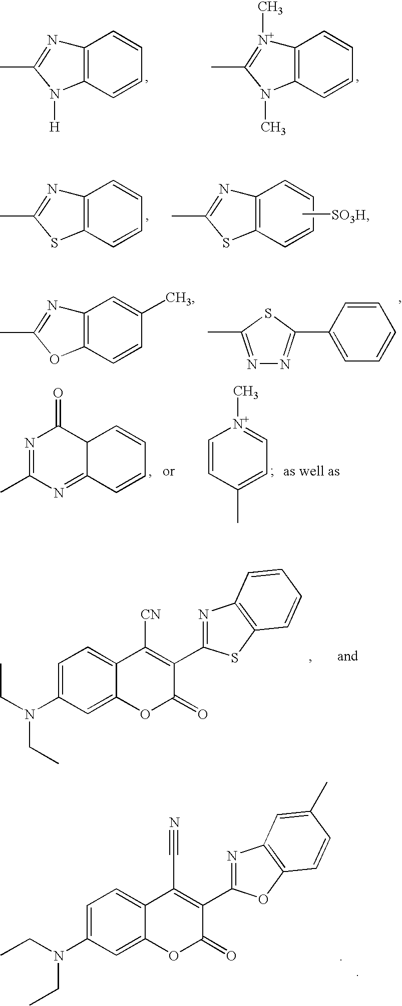
f) Phenoxazine colorants of formula 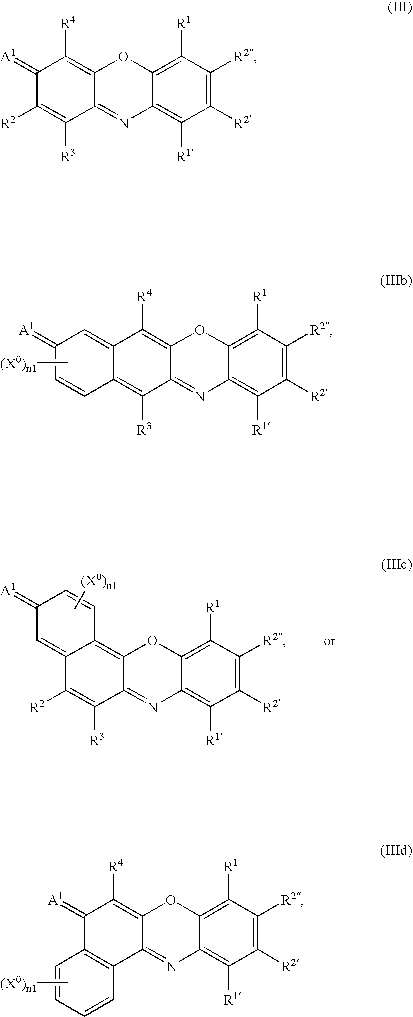
wherein R^{2″} has the meanings provided above for R^{2′}. Optionally A¹ can be combined with each of R² and R⁴ to form a five- or six-membered ring or can be combined with each of R² and R⁴ to form two fused six-membered rings, n1, X⁰, A¹, R¹, R^{1′}, R^{2′}, R², R³ and R⁴ are as defined above.
g) Napthalimide Colorants

A very wide variety of naphthalimide colorants are known. Only a few important representative examples, which show exceptionally brilliant, greenish-yellow fluorescent colors, are shown below: 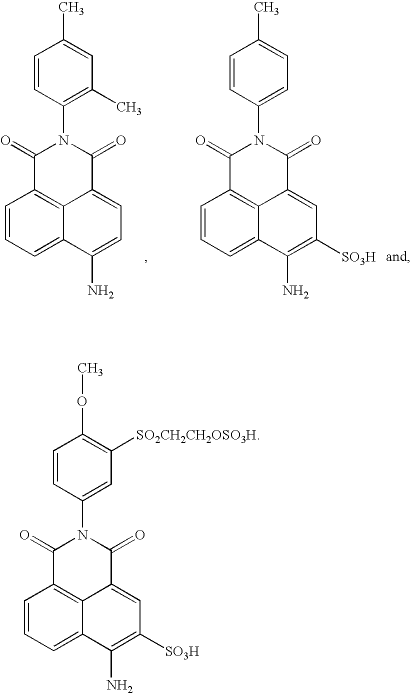
h) Naphtholactam Colorants

Naphtholactam colorants have colors ranging from yellow to red. Only a few important representative examples are shown below: 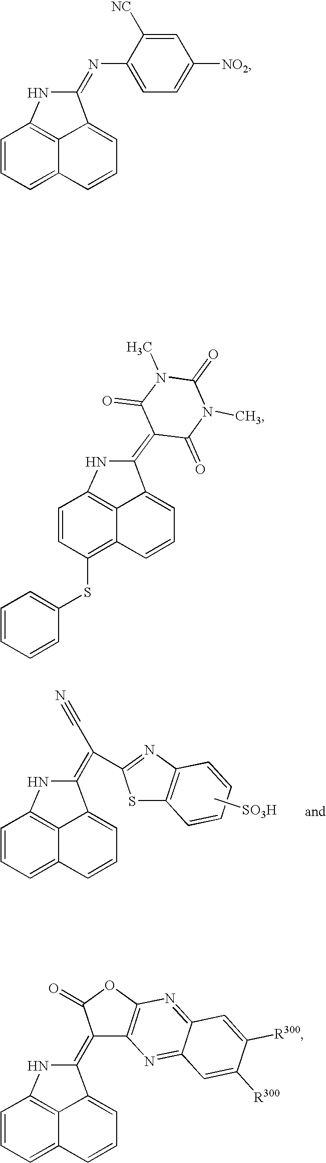
wherein R³⁰⁰ is H, C₁-C₈alkyl, or C₁-C₈alkoxy.
i) Aziactone Colorants:

Only a few important representative examples are shown below: 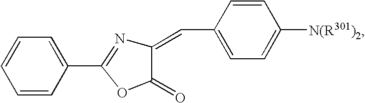
wherein R³⁰¹ is C₁-C₈alkyl. 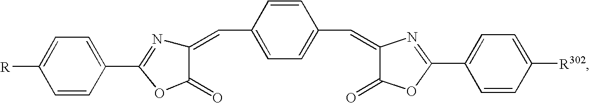
wherein R³⁰² is H, or methoxy.
j) Methine Colorants:

Only a few important representative examples are shown below: 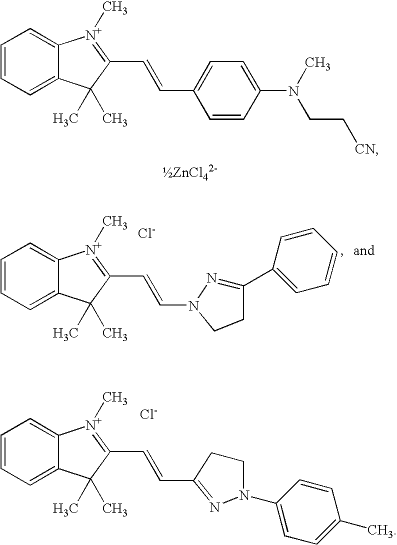
k) Oxazine and Thiazine Colorants

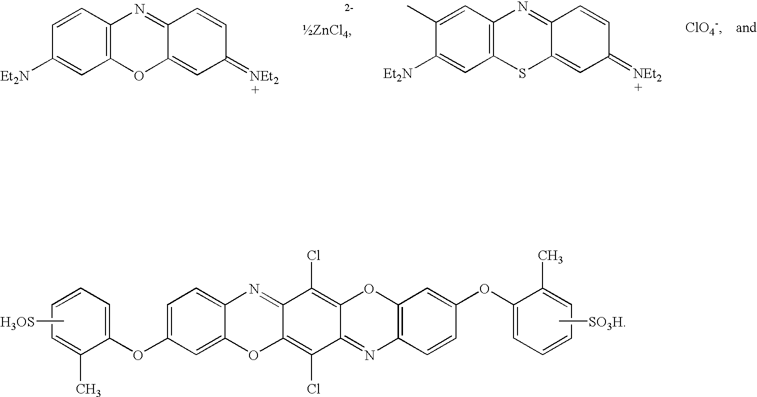

Examples of further preferred fluorescent colorants are:

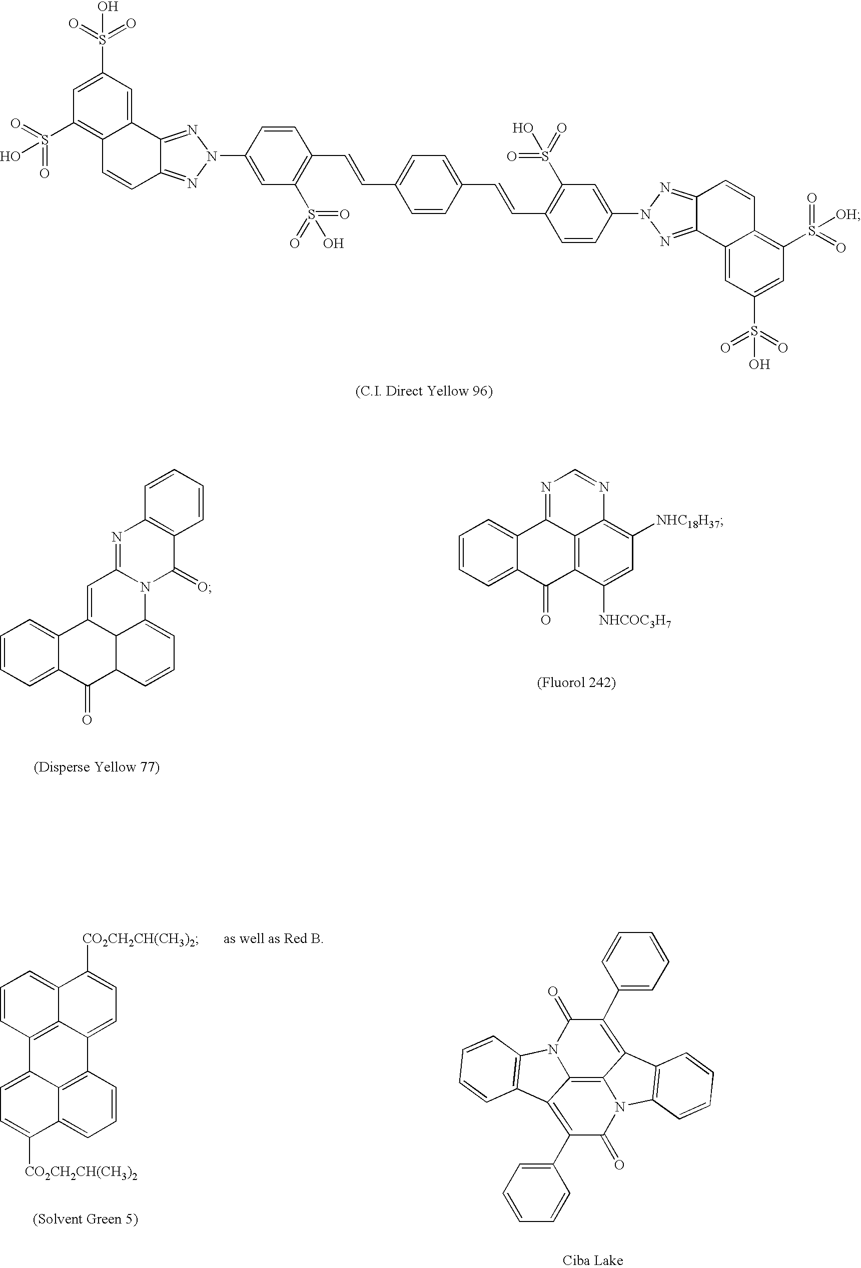

Another preferred pigment is the condensation product of 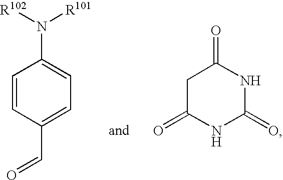
wherein R¹⁰¹ and R¹⁰² are independently hydrogen or C₁-C₁₈ alkyl, such as for example, methyl, ethyl, n-propyl, isopropyl, n-butyl, sec-butyl, isobutyl, tert-butyl, n-amyl, tert-amyl, hexyl, heptyl, octyl, 2-ethylhexyl, nonyl, decyl, dodecyl, tetradecyl, hexadecyl or octadecyl. Preferably R¹⁰¹ and R¹⁰² are methyl. The condensation product is of formula 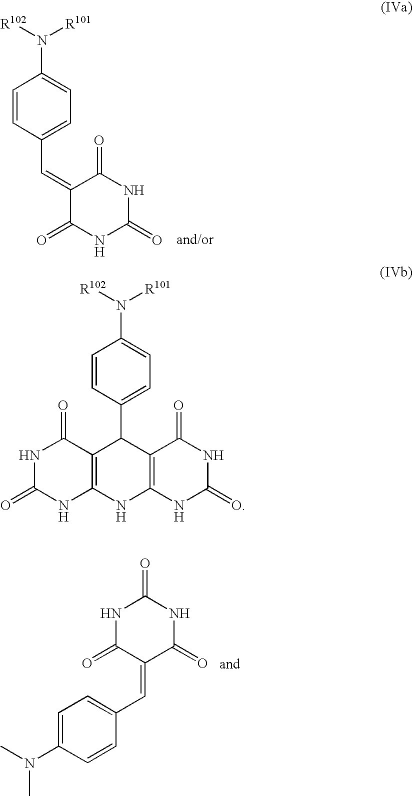
dimer are especially preferred. In case of the above pigment it is advantageous to produce the pigment in situ in the pores of the SiO_{z} flakes. Barbituric acid can, for example, be diluted in a solvent, such as formic acid. To this solution the porous SiO_{z} flakes can be added under stirring. After stirring the suspension can be filtered and the residue can be dried at elevated temperature in vacuo. The obtained product can be redispersed in a solvent, such as ethanol, triethylamine can be added, the mixture can be heated to 78° C. Then a solution of dimethylaminobenzaldehyd in ethanol using a heatable dropping funnel can be slowly added while stirring.

The condensation product of dialkylamino benzaldehyde and barbituric acid enhances plant growth in greenhouses, when incorporated into the thermoplastic polymer film covering the greenhouse. A part of the near UV light is filtered out by this condensation product and transformed into fluorescent light of substantially longer wavelength, which is believed to be responsible for the faster growth of many plants.

The incorporation of the condensation product of dialkylamino benzaldehyde and barbituric acid into the pores of the SiO_{z} flakes can significantly prolong the lifetime of the polymer film. The fluorescence of the condensation product remains high and the plant growth effect is retained over a long time. The condensation product itself is colored absorbing mainly in the near UV range, whereas the Stokes shift of the fluorescence light is large, emitting light of reddish color. This fluorescence increases the light transmitted in the red region of the visible light spectrum (maximum emission approximately at 635 nm) with significant effects on crop's yield and quality, such as stem's length, thickness and growing cycle.

The product is very good compatible with a variety of polymers and with other frequently used additives. It can, therefore, be used in polymer compositions for agricultural applications in the form of films for greenhouses and small tunnel covers, films or filaments for shading nets and screens, mulch films, non-wovens or molded articles for the protection of young plants (cf. EP-A-1413599).

SiO_{z} flakes, comprising luminescent compounds having a maximum emission at approximately 600 to 640 nm can be used for the same purpose.
l) diketopyrrolopyrroles: 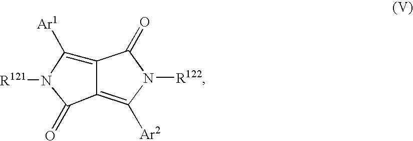
wherein
R¹²¹ and R¹²² are independently of each other an organic group, and
Ar¹ and Ar² are independently of each other an aryl group or an heteroaryl group, which can optionally be substituted.

The term “aryl group” in the definition of Ar¹ and Ar² is typically C₆-C₃₀aryl, such as phenyl, indenyl, azulenyl, naphthyl, biphenyl, terphenylyl or quadphenylyl, as-indacenyl, s-indacenyl, acenaphthylenyl, phenanthryl, fluoranthenyl, triphenlenyl, chrysenyl, naphthacen, picenyl, perylenyl, pentaphenyl, hexacenyl, pyrenyl, or anthracenyl, preferably phenyl, 1-naphthyl, 2-naphthyl, 9-phenanthryl, 2- or 9-fluorenyl, 3- or 4-biphenyl, which may be unsubstituted or substituted. Examples of C₆-C₁₈aryl are phenyl, 1-naphthyl, 2-naphthyl, 3- or 4-biphenyl, 9-phenanthryl, 2- or 9-fluorenyl, which may be unsubstituted or substituted.

The term “heteroaryl group”, especially C₂-C₃₀heteroaryl, is a ring, wherein nitrogen, oxygen or sulfur are the possible hetero atoms, and is typically an unsaturated heterocyclic radical with five to 18 atoms having at least six conjugated 7-electrons such as thienyl, benzo[b]thienyl, dibenzo[b,d]thienyl, thianthrenyl, furyl, furfuryl, 2H-pyranyl, benzofuranyl, isobenzofuranyl, 2H-chromenyl, xanthenyl, dibenzofuranyl, phenoxythienyl, pyrrolyl, imidazolyl, pyrazolyl, pyridyl, bipyridyl, triazinyl, pyrimidinyl, pyrazinyl, 1H-pyrrolizinyl, isoindolyl, pyridazinyl, indolizinyl, isoindolyl, indolyl, 3H-indolyl, phthalazinyl, naphthyridinyl, quinoxalinyl, quinazolinyl, cinnolinyl, indazolyl, purinyl, quinolizinyl, chinolyl, isochinolyl, phthalazinyl, naphthyridinyl, chinoxalinyl, chinazolinyl, cinnolinyl, pteridinyl, carbazolyl, 4aH-carbazolyl, carbolinyl, benzotriazolyl, benzoxazolyl, phenanthridinyl, acridinyl, perimidinyl, phenanthrolinyl, phenazinyl, isothiazolyl, phenothiazinyl, isoxazolyl, furazanyl or phenoxazinyl, preferably the above-mentioned mono- or bicyclic heterocyclic radicals, which may be unsubstituted or substituted.

R¹²¹ and R¹²² may be the same or different and are preferably selected from a C₁-C₂₅alkyl group, which can be substituted by fluorine, chlorine or bromine, an allyl group, which can be substituted one to three times with C₁-C₄alkyl, a cycloalkyl group, a cycloalkyl group, which can be condensed one or two times by phenyl which can be substituted one to three times with C₁-C₄-alkyl, halogen, nitro or cyano, an alkenyl group, a cycloalkenyl group, an alkynyl group, a haloalkyl group, a haloalkenyl group, a haloalkynyl group, a ketone or aldehyde group, an ester group, a carbamoyl group, a ketone group, a silyl group, a siloxanyl group, A³ or —CR¹²⁷R¹²⁸—(CH₂)ₘ-A³, wherein
R¹²⁷ and R¹²⁸ independently from each other stand for hydrogen, or C₁-C₄alkyl, or phenyl, which can be substituted one to three times with C₁-C₄alkyl,
A³ stands for aryl or heteroaryl, in particular phenyl or 1 - or 2-naphthyl, which can be substituted one to three times with C₁-C₈alkyl and/or C₁-C₈alkoxy, and m stands for 0, 1, 2, 3 or 4.

Fluorescent diketopyrrolopyrroles (including compositions) of formula I are known and are described, for example, in EP-A-0133156, U.S. Pat. No. 4,585,878, EP-A-0353184, EP-A-0787730, WO98/25927, U.S. Pat. No. 5,919,944, EP-A-0787731, EP-A-0811625, WO98/25927, EP-A-1087005, EP-A-1087006, WO03/002672, WO03/022848, WO03/064558, WO04/009710, WO04/090046, WO05/005571, EP04106432.0, H. Langhals et al. Liebigs Ann. 1996, 679-682:

| | | Abs. (nm) | Fluores. (nm) |
|---|---|---|---|
| Ar¹ = Ar² | R¹²¹ = R¹²² | [CHCl₃] | [CHCl₃] |
| phenyl | phenyl | 464, 484 | 520, 555 (sh) |
| phenyl | 4-methylphenyl | 470, 488 | 521, 549 (sh) |
| phenyl | 2,3-dimethylphenyl | 469, 492 | 524, 555 (sh) |
| phenyl | 4-t-bu-phenyl | 467, 489 | 519, 553 (sh) |
| phenyl | phenyl & 4-t-bu-phenyl | 467, 489 | 521, 560 (sh) |

US-A-5,354,869:

| Ar¹ = Ar² | R¹²¹ = R¹²² | Abs. (nm) | Fluores. (nm) |
|---|---|---|---|
| 2-methoxyphenyl | methyl | 454 | 514 |
| 2-methoxyphenyl & phenyl | methyl | 464 | 518 |

Compositions comprising DPPs are, for example, described in WO041090046, WO05/005571 and European patent application 04103025.5 (PCT/EP2005/______).

The composition comprises, for example, as described in WO05/005571, a diketopyrrolo-pyrrole compound the absorption of which is in the range of from about 440 to about 500 nm, especially in the range of from about 450 to about 490 nm, and which shows photoluminescence the peak of which is in the range of from 530 to 570 nm, especially in the range of from 540 to 570 nm, and a fluorescent compound the absorption peak of which is in the range of from about 530 to about 570 nm and which shows photoluminescence the peak of which is in the range of from about 580 to about 650 nm.

The following DPP compounds V and Va are especially preferred:

| Cpd. | Ar¹ = Ar² | R¹²¹ = R¹²² | Abs. (nm) | Fluores. (nm) |
|---|---|---|---|---|
| A-1 | 3-methylphenyl | 1-phenylethyl | 460 | 520 |
| A-2 | phenyl | 1-phenylethyl | 464 | 520 |
| A-3 | 4-methylphenyl | 1-phenylpropyl | 462 | 521 |
| A-4 | 4-methylphenyl | diphenylmethyl | 463 | 521 |
| A-5 | 4-methylphenyl | 1-phenylethyl | 464 | 521 |
| A-6 | 3-methoxyphenyl | 1-phenylethyl | 466 | 522 |
| A-7 | 3-methylphenyl | 3-chlorobenzyl | 466 | 526 |
| A-8 | 3-methylphenyl | 3-methylbenzyl | 470 | 527 |
| A-9 | 3-methylphenyl | 3,5-di-t-butylbenzyl | 470 | 527 |
| A-10 | 4-methylphenyl | 3,5-di-t-butylbenzyl | 471 | 527 |
| A-11 | 3-methylphenyl | 3,5-dimethylbenzyl | 472 | 528 |
| A-12 | 4-methylphenyl | 3-methoxybenzyl | 475 | 528 |
| A-13 | phenyl | 3,5-di-t-butylbenzyl | 470 | 529 |
| A-14 | 4-methylphenyl | 4-t-butylbenzyl | 474 | 529 |
| A-15 | 4-methylphenyl | 3-methylbenzyl | 474 | 529 |
| A-16 | 4-methylphenyl | 4-phenylbenzyl | 476 | 529 |
| A-17 | 4-methylphenyl | 2-methylbenzyl | 486 | 529 |
| A-18 | phenyl | n-hexyl | 470 | 530 |
| A-19 | 3-methoxyphenyl | 3-chlorobenzyl | 473 | 530 |
| A-20 | 4-methylphenyl | 3,5,-dimethylbenzyl | 474 | 530 |
| A-21 | 4-ethylphenyl | 3-methylbenzyl | 474 | 530 |
| A-22 | 4-ethylphenyl | 3,5-di-t-butylbenzyl | 474 | 530 |
| A-23 | 3-methoxyphenyl | 3,5-di-t-butylbenzyl | 475 | 530 |
| A-24 | 4-methylphenyl | 4-methylbenzyl | 476 | 530 |
| A-25 | 3-methylphenyl | allyl | 477 | 530 |
| A-26 | 4-i-propylphenyl | benzyl | 478 | 530 |
| A-27 | 4-i-propylphenyl | 3,5-di-t-butylbenzyl | 471 | 531 |
| A-28 | 4-ethylphenyl | benzyl | 474 | 531 |
| A-29 | 4-methylphenyl | 2-naphthylmethyl | 474 | 531 |
| A-30 | 3-methoxyphenyl | 3-methylbenzyl | 476 | 531 |
| A-31 | 4-i-propylphenyl | 3,5-dimethylbenzyl | 476 | 531 |
| A-32 | 4-t-butylphenyl | 3,5-di-t-butylbenzyl | 477 | 531 |
| A-33 | 4-ethylphenyl | 3,5-dimethylbenzyl | 478 | 531 |
| A-34 | 4-methylphenyl | 2-phenylbenzyl | 479 | 531 |
| A-35 | phenyl | —(CH₂)₆OC(O)C(CH₃)═CH₂ | 470 | 532 |
| A-36 | 4-t-butylphenyl | benzyl | 476 | 532 |
| A-37 | 4-i-propylphenyl | 3-methylbenzyl | 476 | 532 |
| A-38 | 3-methoxyphenyl | 3,5-dimethylbenzyl | 478 | 532 |
| A-39 | 3-methoxyphenyl | allyl | 478 | 532 |
| A-40 | 4-t-butylphenyl | 3-methylbenzyl | 480 | 532 |
| A-41 | phenyl | —(CH₂)₆—OH | 470 | 533 |
| A-42 | 3-methylphenyl | 3-methyl-2-buten-yl | 474 | 533 |
| A-43 | 4-t-butylphenyl | 3,5-dimethylbenzyl | 484 | 533 |
| A-44 | 4-methylphenyl | methyl | 485 | 533 |
| A-45 | 4-methylphenyl | n-butyl | 475 | 534 |
| A-46 | 3-(4-phenyl)phenyl | 3,5-dimethylbenzyl | 477 | 534 |
| A-47 | phenyl | methyl | 483 | 534 |
| A-48 | 4-chlorophenyl | 3,5-di-t-butylbenzyl | 476 | 536 |
| A-49 | 1-naphthyl | ethyl | 443 | 538 |
| A-50 | 1-naphthyl | n-butyl | 447 | 538 |
| A-51 | 1-naphthyl | n-C₁₂H₂₅ | 447 | 538 |
| A-52 | 1-naphthyl | n-C₁₈H₃₇ | 450 | 543 |
| A-53 | 3-(4-methyl- | ethyl | 478 | 537 |
| | phenyl)phenyl | | | |
| A-54 | 3,5-di-chlorophenyl | 3,5-dimethylbenzyl | 442 | 532 |
| A-55 | 2-methoxyphenyl | 3,5-dimethylbenzyl | 443 | 519 |
| A-56 | 1-naphthyl | acetyl | 439 | 524 |
| A-57 | 1-naphthyl | benzoyl | 448 | 531 |
| A-58 | 1-naphthyl | n-hexyl | 447 | 538 |
| A-59 | 1-naphthyl | —(CH₂)₆—OH | 449 | 539 |
| A-60 | 1-naphthyl | —(CH₂)₆OC(O)C(CH₃)═CH₂ | 449 | 539 |
| A-61 | 4-methylphenyl | n-hexyl | 475 | 534 |
| A-62 | 4-methylphenyl | —(CH₂)₆—OH | 475 | 536 |
| A-63 | 4-methylphenyl | —(CH₂)₆OC(O)C(CH₃)═CH₂ | 475 | 536 |
| A-64 | 3-methoxyphenyl | n-hexyl | 478 | 536 |
| A-65 | 4-t-butylphenyl | n-hexyl | 480 | 537 |
| A-66 | 3-methylphenyl | n-hexyl | 474 | 536 |

| Cpd. | Ar¹ = Ar² | R¹²¹ = R¹²² | Abs. (nm) | Fluores. (nm) |
|---|---|---|---|---|
| B-1 | 3-cyanophenyl | 3,5-di-t-butylbenzyl | 478 | 540 |
| B-2 | 2-naphthyl | 1-phenylethyl | 479 | 544 |
| B-3 | 4-biphenyl | 1-phenylpropyl | 479 | 544 |
| B-4 | phenyl, 4-biphenyl | 3,5-di-t-butylbenzyl | 479 | 544 |
| B-5 | 4-bromo-3-methylphenyl | ethyl | 480 | 546 |
| B-6 | 4-biphenyl | diphenylmethyl | 484 | 546 |
| B-7 | 4-biphenyl | 1-phenylethyl | 481 | 547 |
| B-8 | phenyl, 4-biphenyl | 3,5-dimethylbenzyl | 482 | 547 |
| B-9 | 4-(4-phenyl)-3- | 3,5-dimethylbenzyl | 485 | 547 |
| | methylphenyl | | | |
| B-10 | 4-biphenyl | 2,2-dimethylpropyl | 478 | 549 |
| B-11 | 2-naphthyl | 3-phenylbenzyl | 487 | 552 |
| B-12 | 4-biphenyl | 3,5-di-t-butylbenzyl | 490 | 552 |
| B-13 | 4-biphenyl | 3-methyl-2-butenyl | 494 | 552 |
| B-14 | 2-naphthyl | 3,5-di-t-butylbenzyl | 487 | 553 |
| B-15 | 2-naphthyl | 3-methoxybenzyl | 491 | 553 |
| B-16 | 2-naphthyl | 4-phenylbenzyl | 487 | 554 |
| B-17 | 2-naphthyl | benzyl | 489 | 554 |
| B-18 | 2-naphthyl | 4-methylbenzyl | 490 | 554 |
| B-19 | 4-biphenyl | 4-cyanobenzyl | 486 | 555 |
| B-20 | 4-biphenyl | 3-phenylbenzyl | 490 | 555 |
| B-21 | 4-biphenyl | 3-chlorobenzyl | 491 | 555 |
| B-22 | 2-naphthyl | 2-methylbenzyl | 494 | 555 |
| B-23 | 2-naphthyl | 3,5-dimethylbenzyl | 490 | 556 |
| B-24 | 4-biphenyl | 3-methoxybenzyl | 491 | 556 |
| B-25 | 9-phenanthrenyl | benzyl | 454 | 557 |
| B-26 | 4-biphenyl | 4-methylbenzyl | 489 | 557 |
| B-27 | 4-biphenyl | 4-phenylbenzyl | 491 | 557 |
| B-28 | 4-biphenyl | 3,5-dimethylbenzyl | 493 | 557 |
| B-29 | 4-biphenyl | 2-naphthylmethyl | 495 | 557 |
| B-30 | 6-methoxynaphth-2-yl | 3,5-di-t-butylbenzyl | 496 | 558 |
| B-31 | 6-methoxynaphth-2-yl | 3-methylbenzyl | 498 | 558 |
| B-32 | 2-naphthyl | 2-phenylethyl | 488 | 559 |
| B-33 | 4-biphenyl | 3-pheny-2-propenyl | 492 | 559 |
| B-34 | 6-methoxynaphth-2-yl | 3-phenylbenzyl | 496 | 559 |
| B-35 | 9-phenanthryl | n-butyl | 447 | 561 |
| B-36 | 4-biphenyl | 2-phenylethyl | 489 | 561 |
| B-37 | 9-phenanthryl | allyl | 445 | 562 |
| B-38 | 4-biphenyl | n-butyl | 492 | 562 |
| B-39 | 4-phenoxyphenyl | 3,5-dimethylbenzyl | 487 | 539, 571 |
| B-40 | 4-biphenyl | n-hexyl | 490 | 555 |
| B-41 | 4-biphenyl | —(CH₂)₆—OH | 491 | 556 |
| B-42 | 4-biphenyl | —(CH₂)₆OC(O)C(CH₃)═CH₂ | 491 | 557 |
| B-43 | 4-biphenyl | n-C₁₂H₂₅ | 489 | 555 |

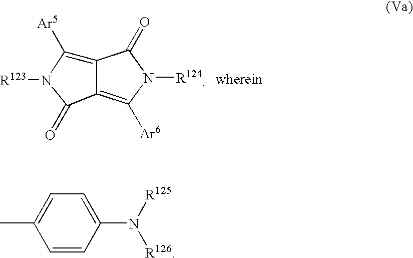

| | | | | Abs. | Fluores. |
|---|---|---|---|---|---|
| Cpd. | R¹²⁵ | R¹²⁶ | R¹²³ = R¹²⁴ | (nm) | (nm) |
| C-1 | CH₃ | CH₃ | 3-bromobenzyl | 541 | 582 |
| C-2 | phenyl | phenyl | methyl | 544 | 590 |
| C-3 | phenyl | 3,5-di-t-butylbenzyl | methyl | 533 | 591 |
| C-4 | phenyl | 1-naphthyl | methyl | 536 | 591 |
| C-5 | phenyl | phenyl | allyl | 540 | 591 |
| C-6 | phenyl | phenyl | benzyl | 541 | 594 |
| C-7 | phenyl | phenyl | 3-methylbenzyl | 542 | 594 |
| C-8 | phenyl | phenyl | 3,5-dimethylbenzyl | 543 | 594 |
| C-9 | 4-methylphenyl | 4-methylphenyl | n-butyl | 533 | 596 |
| C-10 | 4-methylphenyl | 4-methylphenyl | 3,5-di-t-butylbenzyl | 536 | 596 |
| C-11 | Phenyl | phenyl | 4-fluorobenzyl | 542 | 597 |
| C-12 | phenyl | phenyl | 3-bromobenzyl | 543 | 597 |
| C-13 | phenyl | phenyl | 4-bromobenzyl | 544 | 597 |
| C-14 | 2-naphthyl | 2-naphthyl | n-butyl | 537 | 599 |
| C-15 | phenyl | phenyl | 3,5-dibromobenzyl | 542 | 599 |
| C-16 | phenyl | 2-naphthyl | benzyl | 544 | 599 |
| C-17 | phenyl | phenyl | 2-bromobenzyl | 553 | 600 |
| C-18 | phenyl | phenyl | 3-cyanobenzyl | 544 | 601 |
| C-19 | phenyl | phenyl | 4-cyanobenzyl | 549 | 601 |
| C-20 | 4-methylphenyl | 4-methylphenyl | benzyl | 551 | 602 |
| C-21 | 2-naphthyl | 2-naphthyl | benzyl | 547 | 603 |
| C-22 | 4-methoxyphenyl | 4-methoxyphenyl | n-butyl | 540 | 605 |
| C-23 | 4-biphenyl | phenyl | methyl | 547 | 606 |
| C-24 | phenyl | phenyl | 3,4-dicyanobenzyl | 556 | 606 |
| C-25 | 4-methylphenyl | 4-methylphenyl | 4-cyanobenzyl | 557 | 612 |
| C-26 | 4-methoxyphenyl | 4-methoxyphenyl | benzyl | 550 | 613 |
| C-27 | 4-methoxyphenyl | 4-methoxyphenyl | n-hexyl | 542 | 606 |
| C-28 | 4-methoxyphenyl | 4-methoxyphenyl | —(CH₂)₆—OH | 543 | 608 |
| C-29 | 4-methoxyphenyl | 4-methoxyphenyl | —(CH₂)₆OC(O)C(CH₃)═CH₂ | 543 | 608 |
| C-30 | phenyl | phenyl | n-hexyl | 546 | 595 |
| C-31 | phenyl | phenyl | —(CH₂)₆—OH | 546 | 598 |
| C-32 | phenyl | phenyl | —(CH₂)₆OC(O)C(CH₃)═CH₂ | 546 | 598 |
| C-33 | phenyl | phenyl | n-hexyl | 536 | 598 |
| C-34 | 4-methylphenyl | 4-methylphenyl | —(CH₂)₆—OH | 548 | 604 |
| C-35 | 4-methylphenyl | 4-methylphenyl | —(CH₂)₆OC(O)C(CH₃)═CH₂ | 542 | 602 |
| C-36 | 4-methylphenyl | 4-methylphenyl | n-C₁₂H₂₅ | 543 | 598 |

m) Perylenes: 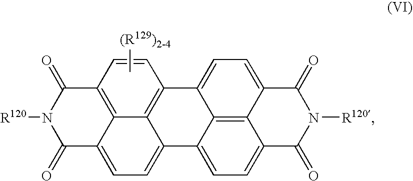
wherein R¹²⁰, R^{120′} and R¹²⁹ are independently of each other organic substituents.
R¹²⁰ and R^{120′} controlls solubility, aggregation and photostability. R¹²⁹ contrails absorption maximum (shade) and solubility.
R¹²⁰ and R^{120′} may be the same or different and are preferably selected from a C₁-C₂₅alkyl group, which can be substituted by fluorine, chlorine or bromine, an allyl group, which can be substituted one to three times with C₁-C₄alkyl, a cycloalkyl group, a cycloalkyl group, which can be condensed one or two times by phenyl which can be substituted one to three times with C₁-C₄alkyl, halogen, nitro or cyano, an alkenyl group, a cycloalkenyl group, an alkynyl A group, a haloalkyl group, a haloalkenyl group, a haloalkynyl group, a ketone or aldehyde group, an ester group, a carbamoyl group, a ketone group, a silyl group, a siloxanyl group, A³ or —CR¹²⁷R¹²⁸—(CH₂)ₘ-A³, wherein
R¹²⁷ and R¹²⁸ independently from each other stand for hydrogen, or C₁-C₄alkyl, or phenyl, which can be substituted one to three times with C₁-C₄alkyl,
A³ stands for aryl or heteroaryl, in particular phenyl or 1- or 2-naphthyl, which can be substituted one to three times with C₁-C₈alkyl and/or C₁-C₈alkoxy, and m stands for 0, 1, 2, 3 or 4.

Fluorescent perylenes (including compositions) are known and are described, for example, in U.S. Pat. No. 5,650,513, U.S. Pat. No. 6,491,749, U.S. Pat. No. 6,491,749, EP-A-57436, EP-B-638613, EP-A-711812, EP-A-977754, and EP-A-1019388:
Perylenmonoimides: 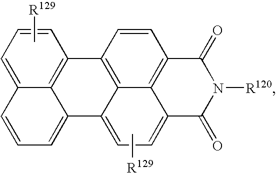
wherein R¹²⁹ and R¹²⁰ are as defined above.
Nucleus-extended perylenebisimides of general formulae 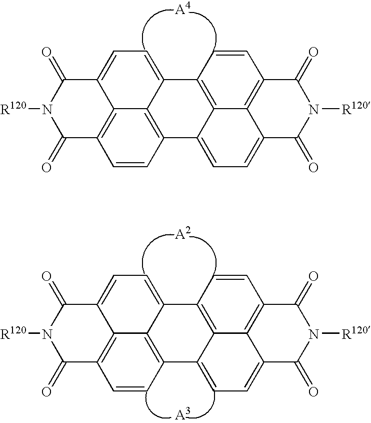
wherein
R¹²⁰ and R^{120′} are each independently of the other unsubstituted or substituted C₁-C₂₄alkyl, C₁-C₂₄cycloalkyl, or C₆-C₁₀aryl, and
A⁴ and A³ are each independently of the other —S—, —S—S—, —CH═CH—,
R¹³⁰OOC—C(−)═C(−)—COOR¹³⁰, —N═N— or —N(R¹³¹)—, or a linkage selected from the group consisting of the organic radicals of formulae 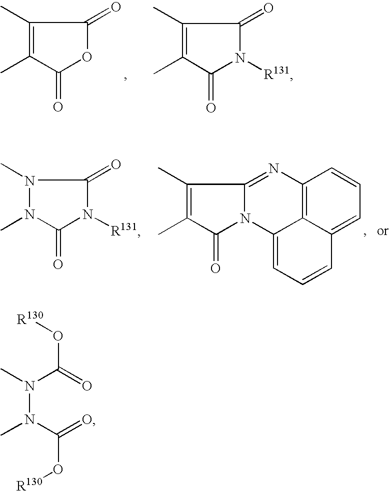
wherein
R¹³⁰ is hydrogen, C₁-C₂₄alkyl or C₁-C₂₄cycloalkyl,
R¹³¹ is unsubstituted or substituted C₁-C₂₄alkyl, C₁-C₂₄cycloalkyl, phenyl, benzyl, —CO—C₁-C₄alkyl, —CO—C₆H₅ or C₁-C₄alkylcarboxylic acid (C₁-C₄alkyl) ester, and
A² is a linkage of formula 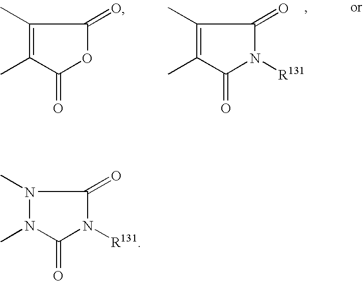
Perylene amidine-imide colorants: 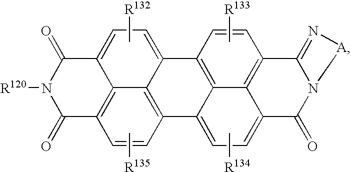
where R¹²⁰ is a secondary C₇₋₄₁alkyl radical or a radical of the formula 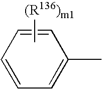
where R¹³⁶ is a branched C₃₋₈alkyl radical and m1 is 1, 2 or 3; A is C₅₋₇cycloalkylene, phenylene, naphthylene, pyridylene, a more highly fused aromatic carbocyclic or heterocyclic radical or a bivalent radical of the formula 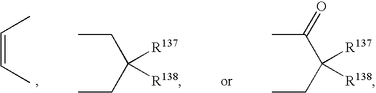
and R¹²⁰ and A may each be substituted by halogen, alkyl, cyano or nitro; R¹³² to R¹³⁵ are each independently of the others hydrogen, alkyl, aryl, heteroaryl, halogen, cyano, nitro, —OR¹³⁹, —COR¹³⁹, —COOR¹³⁹, —OCOR¹³⁹, —CONR¹³⁹R¹⁴⁰, —OCONR¹³⁹R¹⁴⁰, —NR¹³⁹R¹⁴⁰, —NR¹³⁹COR¹⁴⁰, —NR¹³⁹COOR¹⁴⁰, —NR¹³⁹SO₂R¹⁴⁰, —SO₂R¹³⁹, —SO₃R¹³⁹, —SO₂NR¹³⁹R¹⁴⁰ or —N═N—R¹³⁹; and R¹³⁷ to R¹⁴⁰ are each independently of the others C₁₋₄alkyl, phenyl or 4-tolyl.
Perylene-3,4:9,10-tetracarboxylic acid imides of the formula 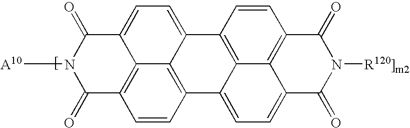
in which A¹⁰ is a di-, tri- or tetravalent carbocyclic or heterocyclic aromatic radical,
R¹²⁰ is H, an alkyl, aralkyl or cycloalkyl group or a carbocyclic or heterocyclic aromatic radical and

m2 is 2, 3 or 4.

| Trade Designation | Source |
|---|---|
| Lumogen ® F 083 | BASF AG |
| Lumogen ® F Orange 240 | BASF AG |

n) Quinacridones:

Fluorescent quinacridones (including compositions) are known and are described, for example, in EP-A-0939972, US200210038867A1, WO/02/099432, WO04/039805 and PCT/EP2005/052841.

Quinacridone compounds of formula 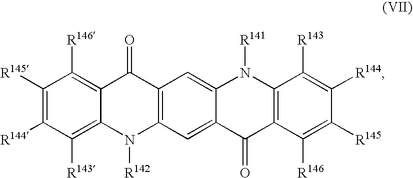
wherein
R¹⁴¹ and R¹⁴² may be the same or different and are selected from a C₁-C₂₅alkyl group, which can be substituted by fluorine, chlorine or bromine, an allyl group, which can be substituted one to three times with C₁-C₄alkyl, a cycloalkyl group, a cycloalkyl group, which can be condensed one or two times by phenyl which can be substituted one to three times with C₁-C₄-alkyl, halogen, nitro or cyano, an alkenyl group, a cycloalkenyl group, an alkynyl group, a haloalkyl group, a haloalkenyl group, a halalkynyl group, a ketone or aldehyde group, an ester group, a carbamoyl group, a ketone group, a silyl group, a siloxanyl group, A³ or —CR¹²⁷R¹²⁸—(CH₂)ₘ-A³, wherein
R¹²⁷ and R¹²⁸ independently from each other stand for hydrogen, or C₁-C₄alkyl, or phenyl, which can be substituted one to three times with C₁-C₄alkyl,
A³ stands for aryl or heteroaryl, in particular phenyl or 1- or 2-naphthyl, which can be substituted one to three times with C₁-C₈alkyl and/or C₁-C₈alkoxy, and m stands for 0, 1, 2, 3 or 4,
R¹⁴³, R^{143′}, R¹⁴⁶ and R^{146′}, independently of one another, represent hydrogen, halogen, C₁-C₁₈alkyl, halogen-substituted C₁-C₁₈alkyl, C₁-C₁₈alkoxy, C₁-C₁₈alkylthio, cycloalkyl, optionally substituted aryl or arylalkyl, wherein the substituents are alkoxy, halogen or alkyl,
R¹⁴⁴ and R^{144′} are independently of each other R¹⁴³, or a group —NAr¹Ar²,
R¹⁴⁵ and R^{145′} are independently of each other R¹⁴³, or a group —NAr³Ar⁴, or
R^{143′} and R^{144′} and/or R¹⁴³ and R¹⁴⁴ together are a group 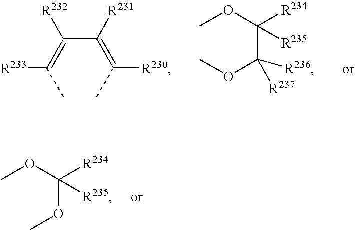
R^{145′} and R^{146′} and/or R¹⁴⁵ and R¹⁴⁶ together are a group 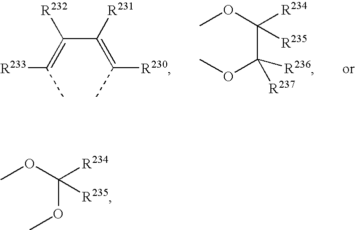
wherein
R²³⁰, R²³¹, R²³² and R²³³ are independently of each other hydrogen, C₁-C₁₈alkyl, halogen-substituted C₁-C₁₈alkyl, C₁-C₁₈alkoxy, or C₁-C₂₈alkylthio,
R²³⁴, R²³⁵, R²³⁶ and R²³⁷ are independently of each other hydrogen, C₁-C₁₈alkyl, halogen-substituted C₁-C₁₈alkyl, C₁-C₁₈alkoxy, or C₁-C₂₈alkylthio,
Ar¹, Ar², Ar³ and Ar⁴ are independently of each other an aryl group, which can optionally be substituted, or a heteroaryl group, which can optionally be substituted. According to European patent application no. 04103025.5 at least one of the groups R¹⁴⁴, R^{144′}, R¹⁴⁵ and R^{145′} is a group —NAr¹Ar², or —NAr³Ar⁴.

Quinacridone compounds, which can emit white light, as described in WO04/039805.
o) (Thio)-Epindolines of formula: 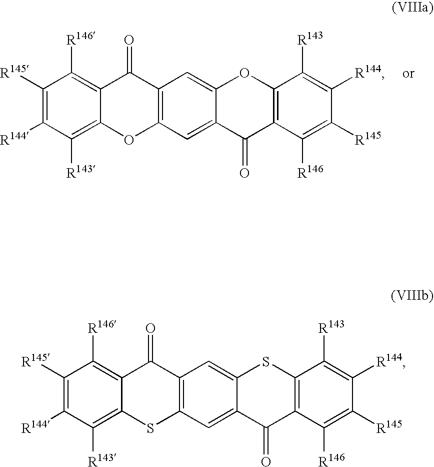
wherein
R¹⁴³, R¹⁴⁴, R¹⁴⁵ and R¹⁴⁶ as well as R^{143′}, R^{144′}, R^{145′} and R^{146′} are as defined above.
p) Benzoxanthenes of formula: 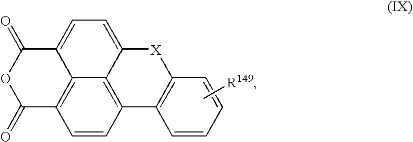
wherein
R¹⁴⁹ is C₁₋₈alkyl, C₁₋₈alkoxy, C₁₋₈thioalkyl, di(C₁₋₈alkyl)amino, or halogen,
X is O, S, NH, or NR¹⁵⁰, wherein R¹⁵⁰ is C₁₋₈alkyl, hydroxy-C₁₋₈alkyl, or C₆₋₁₀aryl.
q) Lactamimides:

For, example, the naphthalenelactamimides described in U.S. Pat. No. 5,886,183: 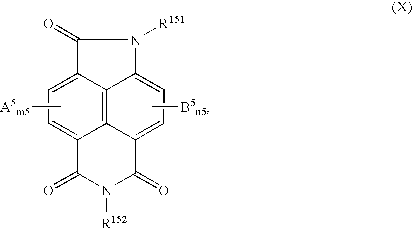
in which
R¹⁵¹ and R¹⁵² independently of one another are C₂-C₂₅alkyl, where the alkyl group is unsubstituted or substituted by halogen, C₆-C₁₀aryl, C₅-C₁₀heteroaryl, or C₃-C₁₀cycloalkyl; C₃-C₁₀cycloalkyl or a radical of the formula 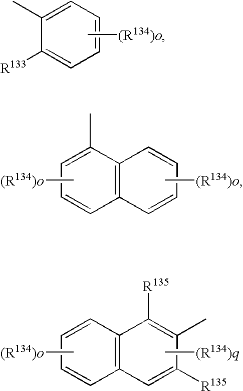
A⁵ and B⁵ independently of one another are C₁-C₆alkyl, C₃-C₆cycloalkyl, C₆-C₁₀aryl, halogen, cyano, nitro, —OR¹³⁶, —SR¹³⁶, —COR¹³⁶, —COOR¹³⁶, —OCOR¹³⁶, —CONR¹³⁶R¹³⁷, —OCONR¹³⁶R¹³⁷, —NR¹³⁶R¹³⁷, —NR¹³⁶COR¹³⁷, —NR¹³⁶COOR¹³⁷, —NR¹³⁶SO₂R¹³⁷, —SO₂R¹³⁷, —SO₃R¹³⁷, —SO₂NR¹³⁶R¹³⁷ or —N═N—R¹³⁶,
R¹³³ to R¹³⁵ independently of one another are halogen, C₁-C₁₂alkyl, phenyl or tolyl, where one R¹³⁵ can also be hydrogen,
R¹³⁶ and R¹³⁷ independently of one another are C₁-C₄alkyl, phenyl or 4-tolyl,
n⁵ and m⁵ independently of one another are 0, 1 or 2,
o is an integer from 0 to 4,
p is an integer from 0 to 3 and
q is 0 or 1.
r) Diphenylmaleimides, for example those described in WO2001019939: 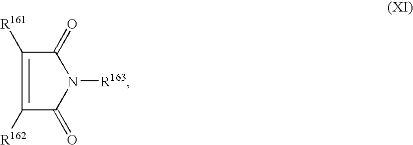
wherein
R¹⁶¹ and R¹⁶² independently from each other stand for 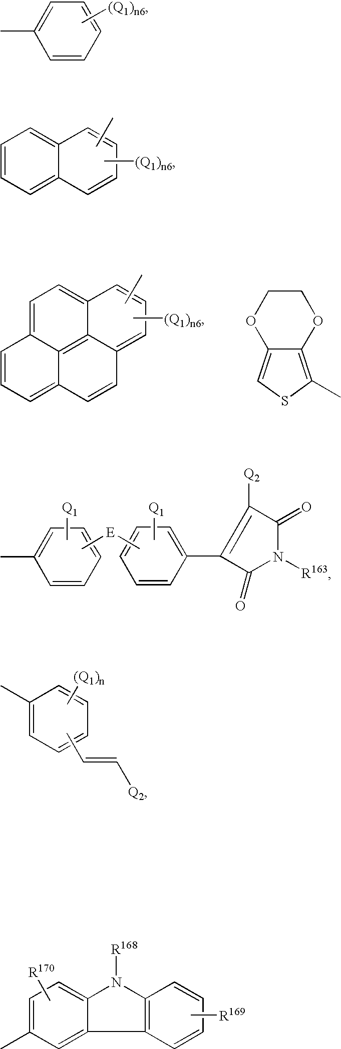
wherein Q₁ stands for hydrogen, halogen, phenyl, -E-C₁-C₈alkyl, -E-phenyl, wherein phenyl can be substituted up to three times with C₁-C₈alkyl, halogen, Cl-C8alkoxy, diphenylamino, —CH═CH-Q₂, wherein Q₂ stands for phenyl, pyridyl, or thiophenyl, which can be substituted up to three times with C₁-C₈alkyl, halogen, C₁-C₈alkoxy, —CN, wherein E stands for oxygen or sulfur, and wherein R¹⁶⁸ stands for C₁-C₈alkyl, phenyl, which can be substituted up to three times with C₁-C₄alkyl, C₁-C₄alkoxy, or dimethylamino, and R¹⁶⁹ and R¹⁷⁰ independently from each other stand for hydrogen, R¹⁶⁸, C₁-C₈alkoxy, or dimethylamino,
or —NR¹⁶⁴R¹⁶⁵, wherein R¹⁶⁴ and R¹⁶⁵, independently from each other stand for hydrogen, phenyl, or C₁-C₈alkyl-carbonyl, or —NR¹⁶⁴R¹⁶⁵ stands for a five- or six-membered ring system, and R¹⁶³ stands for allyl, 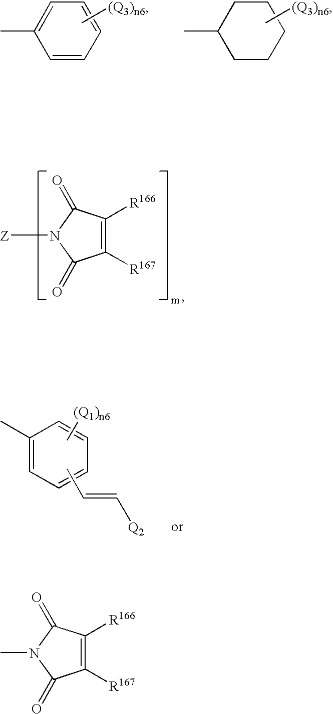
wherein Q₃ stands for hydrogen, halogen, C₁-C₈alkoxy, C₁-C₈alkyl-amido, unsubstituted or substituted C₁-C₈alkyl, unsubstituted or up to three times with halogen, —NH₂, —OH, or C₁-C₈alkyl substituted phenyl,
and Z stands for a di- or trivalent radical selected from the group consisting of substituted or unsubstituted cyclohexylene, preferably 1,4-cyclohexylene, triazin-2,4,6-triyl, C₁-C₆alkylene, 1,5-naphthylene, 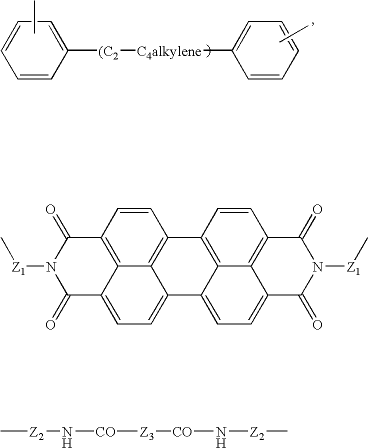
wherein
Z₁, Z₂ and Z₃, independently from each other stand for cyclohexylene or up to three times with C₁-C₄alkyl substituted or unsubstituted phenylene, preferably unsubstituted or substituted 1,4-phenylene, and wherein R¹⁶⁸ and R¹⁶⁷, independently from each other, stand for 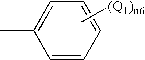
n6 stands for 1, 2 or 3, and m stands for 1 or 2.
s) Acetoacetamides, for example, those described in WO200346086: 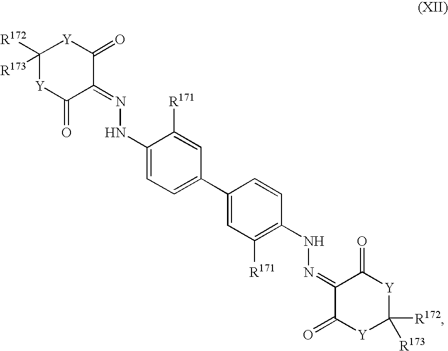
wherein R¹⁷¹ stands for halogen, in particular for chlorine, or C₁-C₄alkoxy, in particular for methoxy, Y stands for —CH₂— or —O—, preferably for —O—, and R¹⁷² and R¹⁷³, independently from each other, stand for hydrogen, C₁-C₈alkyl, or C₆-C₁₄aryl, which may be substituted up to three times with C₁-C₈alkyl, C₁-C₄alkoxy or halogen, preferably for C₁-C₈ alkyl, in particular for methyl.
t) Imidazothiazines: 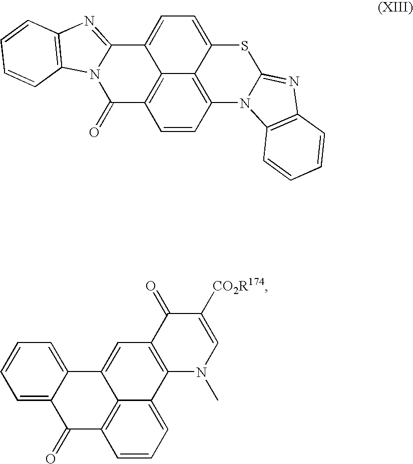
u) Benzanthrones:
wherein R¹⁷⁴ is C₁₋₈alkyl, C₇₋₁₂aralkyl, or C₆₋₁₀aryl.
v) Phthalimides, such as, for example, those described in EP-A456609: 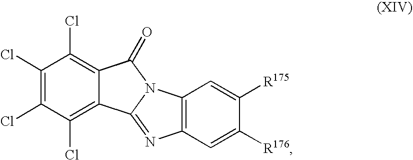
wherein R¹⁷⁵ and R¹⁷⁶ are independently of each other hydrogen, halogen, C₁₋₅alkyl, or C₁₋₃alkoxy.
w) Benzotriazoles, such as, for example, those described in WO03/105538 and PCT/EP2004/053111.
x) Pyrimidines, Triazines, Pyrazines, Pyridines, Triazoles and Dibenzofurans, such as, for example those described in WO04/039786, PCT/EP2004/050146, WO05/023960, PCT/EP2004/052984, and PCT/EP2005/051731, European patent application no. 05103497.3 and 05104599.5.

Another class of luminescent compounds are optical brighteners.

Optical brighteners or, more adequately, fluorescent whitening agents (FWA) are colorless to weakly colored organic compounds that, in solution or applied to a substrate, absorb ultraviolet light (e.g., from daylight at ca. 300-430 nm) and reemit most of the absorbed energy as blue fluorescent light between ca. 400 and 500 nm.

Such compounds are described in “Fluorescent Whitening Agent, Encyclopedia of Chemical Technology, Kirk-Othmer,” 4th ed., 11: 227-241 (1994).

Stilbene derivatives such as, for example, polystyrystilbenes and triazinestilbenes, coumarin derivatives such as, for example, hydroxycoumarins and aminocoumarins, oxazole, benzoxazole, imidazole, triazole and pyrazoline derivatives, pyrene derivatives and porphyrin derivatives, and mixtures thereof, are known as optical brighteners. Such compounds are widely commercially available. They include, but are not limited to, the following derivatives:
a) Distyrylbenzenes

Cyano-substituted 1,4-distyrylbenzenes:

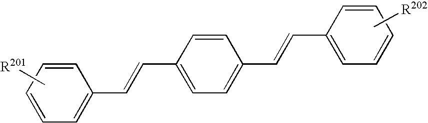

| R²⁰¹ (position) | R²⁰² (position) |
|---|---|
| CN (2) | CN (3) |
| CN (2) | CN (4) |
| CN (3) | CN (3) |
| CN (3) | CN (4) |
| CN (4) | CN (4) |

b) Distyrylbiphenyls

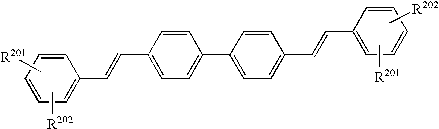

| R²⁰¹ (position) | R²⁰² (position) |
|---|---|
| SO₃Na (3) | Cl (4) |
| OCH₃ (2) | H |
| SO₃Na (2) | H |

c) Divinylstilbenes

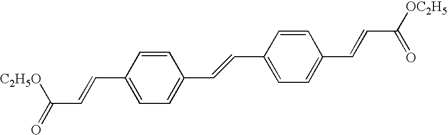

Another divinylstilbene brightener with an even higher efficacy is 4,4′-di(cyanovinyl)stilbene.
d) Triazinylaminostilbenes

The tables below list the important anilino and anilinosulfonic acid representatives of bis(4,4′-triazinylamino)stilbene-2,2′-disulfonic acid. The latter can be employed over a wide pH range. All of the listed compounds are distinguished by high whitening effects, good efficiency, and adequate lightfastness.

Anilino derivatives of bis(4,4′-triazinylamino)stilbene-2,2′-disulfonic acid

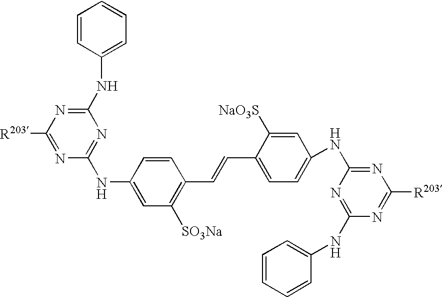

R
—OCH₃
—NH—CH₃
—NH—C₂H₅
—NH—CH₂CH₂OH
—N(CH₃)(CH₂CH₂OH)
—N(CH₂CH₂OH)₂

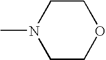

—NH—C₆H₅
—N(CH₂CH₂C(═O)NH)(CH₂CH₂OH)

Anilinosulfonic acid derivatives of bis(4,4′-triazinylamino)stilbene-2,2′-disulfonic acid

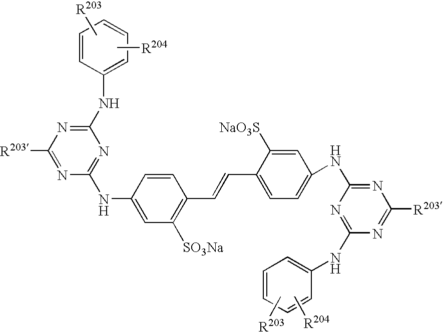

| R^{203′} | R²⁰³ (position) | R²⁰⁴ (position) |
|---|---|---|
| —NH—CH₂CH₂OH | SO₃Na (3) | H |
| —N(CH₂CH₂OH)₂ | SO₃Na (3) | H |
| —N(CH₂CH(OH)CH₃)₂ | SO₃Na (4) | H |
| —N(CH₂CH₂OH)₂ | SO₃Na (4) | H |
| —N(CH₃)(CH₂CH₂OH) | SO₃Na (4) | H |
| —N(C₂H₅)₂ | SO₃Na (2) | SO₃Na (5) |
| —N(CH₂CH₂OH)₂ | SO₃Na (2) | SO₃Na (5) |
| 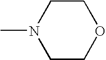 | SO₃Na (2) | SO₃Na (5) |
| —N(CH₂CO₂Na)₂ | SO₃Na (4) | H |

e) Stilbenyl-2H-triazoles
Bis(1,2,3-trazol-2-yl)stilbenes 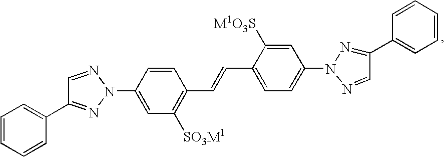
wherein M¹ is K, or Na.
f) Benzoxazoles
Stilbenylbenzoxazoles

5,7-dimethyl-2-(4′-phenylstilben-4-yl)benzoxazole

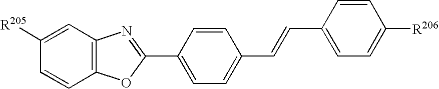

| R²⁰⁵ | R²⁰⁶ |
|---|---|
| CH₃ | COOCH₃ |
| H | 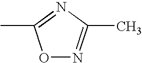 |

Bis(benzoxazoles)

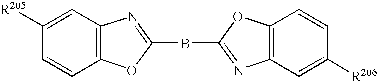

| R²⁰⁵ | R²⁰⁶ | B |
|---|---|---|
| CH₃ | CH₃ | 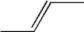 |
| H | H | 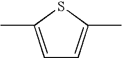 |
| C(CH₃)₃ | C(CH₃)₃ | 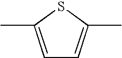 |
| H | H | 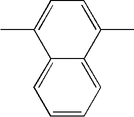 |
| CH₃ | CH₃ | 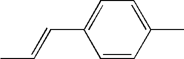 |
| H | H | 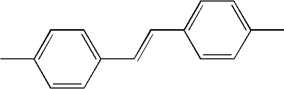 |
| CH₃ | H | 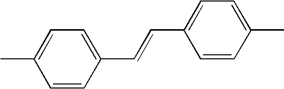 |

g) Furans, Benzo[b]furans, and Benzimidazoles

Furans and benzo[b]furans are further building blocks for optical brighteners. They are used, for example, in combination with benzimidazoles and benzo[b]furans as biphenyl end groups.
Bis(benzo[b]furan-2-yl)biphenyls

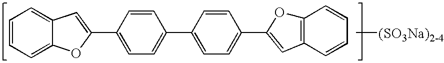

Cationic Benzimidazoles

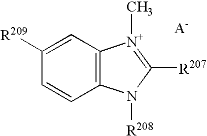

| R²⁰⁷ | R²⁰⁸ | R²⁰⁹ | A⁻ |
|---|---|---|---|
| 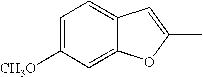 | H | —CH₂CO₂C₂H₅ | Br⁻/Cl⁻ |
| 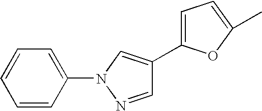 | CH₃ | SO₂CH₃ | CH₃COO⁻ |
| 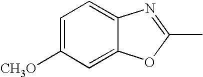 | —CH₂-Ph | H | CH₃OSO₃⁻ |

h) 1,3-Diphenyl-2-pyrazolines
1-(4-Amidosulfonylphenyl)-3-(4-chlorophenyl)-2-pyrazoline

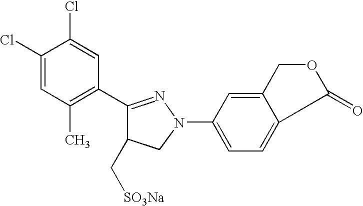

Nonionic and anionic 1,3-diphenyl-2-pyrazolines

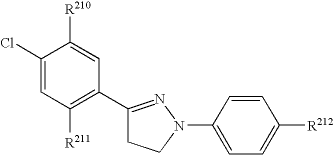

| R²¹⁰ | R²¹¹ | R²¹² |
|---|---|---|
| H | H | SO₂CH₃ |
| H | H | SO₂CH₂CH₂OH |
| H | H | SO₂CH₂CH₂SO₃Na |
| H | H | COONa |
| Cl | CH₃ | SO₂CH₂CH₂SO₃Na |

1,3-Diphenyl-2-pyrazolines

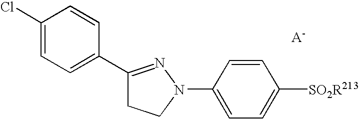

| R²¹³ | A⁻ |
|---|---|
| —(CH₂)₂—⁺NH(CH₃)₂ | H₂PO₃⁻ |
| —(CH₂)₂—⁺NH(CH₃)₂ | HCOO⁻ |
| —CH₂—CH(CH₃)⁺NH(CH₃)₂ | CH₃CH(OH)CO₂⁻ |
| —(CH₂)₂—C(═O)NH—(CH₂)₃—⁺NH(CH₃)₂ | Cl⁻ |
| —(CH₂)₂—O—CH(CH₃)—CH₂—⁺NH(CH₃)₂ | Cl⁻ |
| —NH—(CH₂)₃—⁺N(CH₃)₃ | CH₃OSO₃⁻ |
| —NH—(CH₂)₃—⁺N(CH₃)₂(CH₂CH₂OH) | COO⁻ |

l) Coumarins 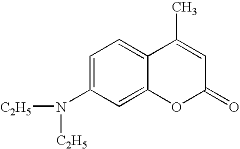
j) Naphthalimides

The 4-aminonaphthalimides and their N-alkylated derivatives are brilliant greenish yellow fluorescent colorants. Acylation of the amino group at the 4-position of the naphthalimide ring shifts the fluorescence toward blue, yielding compounds suitable for use as optical brighteners, such as 4-acetylamino-N-(n-butyl)naphthalimide.

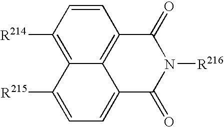

| R²¹⁴ | R²¹⁵ | R²¹⁶ |
|---|---|---|
| OCH₃ | H | CH₃ |
| OC₂H₅ | OC₂H₅ | CH₃ |
| OCH₃ | H | O(CH₂)₃CH₃ |

k) 1,3,5-Triazin-2-yl Derivatives

Representative examples of this class of compounds are compounds of the formula 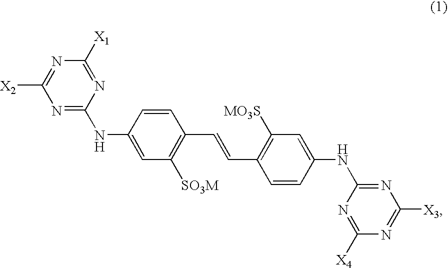
wherein
X₁, X₂, X₃ and X₄ each, independent of the other, represent —NR³⁰¹R³⁰² or —OR³⁰³, wherein R³⁰¹ and R³⁰² are, independently of each other,
hydrogen, cyano, a C₁-C₄alkyl group, which is unsubstituted or substituted by one or two of the following residues selected from the group consisting of C₁-C₄alkoxy, hydroxy, carboxyl or a salt thereof (—CO₂M), cyano, carbonamido, thiol, guanidine, substituted or unsubstituted phenyl, unsubstituted or C₁-C₄alkyl-substituted C₅-C₈cycloalkyl, halogen, a heterocycle and a sulphonic acid residue, and wherein the carbon chain of an alkyl group having two, three or four carbon atoms can be interrupted by oxygen,
or, alternatively, a C₅-C₇cycloalkyl group or
R³⁰¹ and R³⁰², together with the nitrogen atom linking them, complete a 5- or 6-membered heterocyclic ring;
R₃₀₃ represents C₁-C₄alkyl and

M represents H, Na, Li, K, Ca, Mg, ammonium, or ammonium that is mono-, di-, tri- or tetrasubstituted by C₁-C₄alkyl and/or C₂-C₄hydroxyalkyl; especially

| X₁ | X₂ | X₃ | X₄ | M |
|---|---|---|---|---|
| —NH₂ | 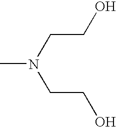 | —NH₂ | 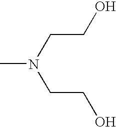 | Na |
| —NH₂ | 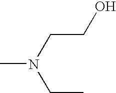 | —NH₂ | 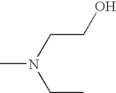 | Na |
| —NH₂ | 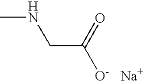 | —NH₂ | 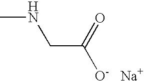 | Na |
| —NH₂ | 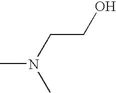 | —NH₂ | 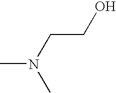 | Na |
| —NH₂ | 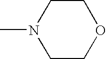 | —NH₂ | 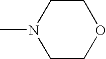 | Na |
| —NH₂ | 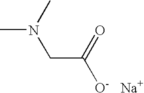 | —NH₂ | 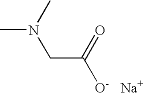 | Na |
| —NH₂ | 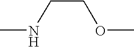 | —NH₂ | 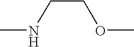 | Na |
| 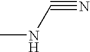 | 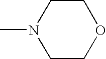 | 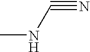 | 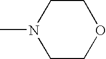 | Na |
| 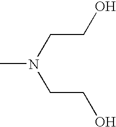 | 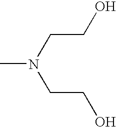 | 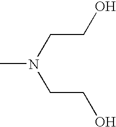 | 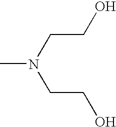 | Na |
| 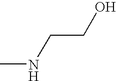 | 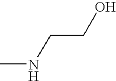 | 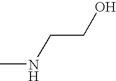 | 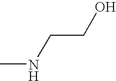 | Na |
| 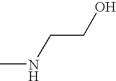 | 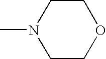 | 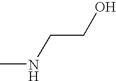 | 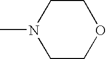 | Na |
| —NH₂ | —NH₂ | —NH₂ | —NH₂ | NH₄ |
| —NH₂ | 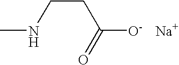 | —NH₂ | 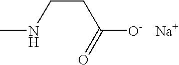 | Na |
| —NH₂ | 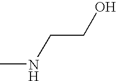 | —NH₂ | 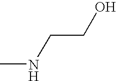 | Na |
| —NH₂ | 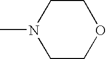 | —NH₂ | 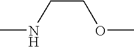 | Na |
| —NH₂ | 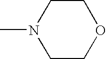 | —NH₂ | 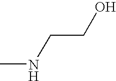 | Na |
| —NH₂ | 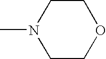 | —NH₂ | 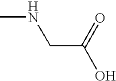 | Na |

or 1-(4,6-dimethoxy-1,3,5-triazin-2-yl)pyrene:

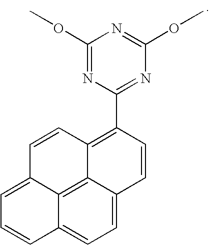

Porous SiO_{z} flakes charged with optical brighteners, i.e. one optical brightener or a mixture of optical brighteners, may be incorporated in variable amounts into cosmetic compositions. Generally, their content is adjusted so as to obtain a desired optical effect, i.e., a visual bleaching effect. Needless to say, their content may also be directly linked to emission power of optical brighteners they contain.

Accordingly the present invention relates also to a cosmetic composition for making up and/or caring for skin, comprising porous SiO_{z} flakes containing at least one optical brightener, wherein the porous mineral particles are provided in a physiologically acceptable medium and to a cosmetic process for lightening the skin, comprising applying the above cosmetic composition to the skin.

Advantageously, compositions according to the invention can give skin onto which they are applied, improved qualities in terms of uniformity, homogeneity, transparency and whiteness. This results in a visual effect of uniform porcelain type.

The SiO_{z} flakes comprising an organic, or inorganic luminescent compound, or composition, can be obtained by a method, which comprises
a) dispersing the SiO_{z} flakes in a solution of the organic, or inorganic luminescent compound, or composition, adding the SiO_{z} flakes to a solution of the organic, or inorganic luminescent compound, or composition, or adding the organic, or inorganic luminescent compound, or composition, to a dispersion of the SiO_{z} flakes,
b) optionally precipitating the organic, or inorganic luminescent compound, or composition, onto the SiO_{z} flakes, and
c) isolating the SiO_{z} flakes comprising the organic, or inorganic luminescent compound, or composition.

Preference is given to a method, which comprises
a) adding the SiO_{z} flakes to a solution of the organic, or inorganic luminescent compound, or composition,
b) optionally precipitating the organic, or inorganic luminescent compound, or composition, onto the SiO_{z} flakes, and
c) subsequently isolating the SiO_{z} flakes comprising the organic, or inorganic luminescent compound, or composition.

Advantageously, the procedure is such that the organic, or inorganic luminescent compound, or composition, is first dissolved in a suitable solvent (I) and then the SiO_{z} flakes are dispersed in the resulting solution. It is, however, also possible, vice versa, for the SiO_{z} flakes first to be dispersed in the solvent (I) and then for the organic, or inorganic luminescent compound, or composition to be added and dissolved.

Any solvent that is miscible with the first solvent and that so reduces the solubility of the organic, or inorganic luminescent compound, or composition, that it is completely, or almost completely, deposited onto the substrate is suitable as solvent (II). In this instance, both inorganic solvents and also organic solvents come into consideration. Isolation of the coated substrate can then be carried out in conventional manner by filtering off, washing and drying.

An alternative process for preparing luminescent SiO_{z} particles comprises
a) vapor-deposition of a separating agent onto a carrier to produce a separating agent layer,
b) then the simultaneous vapor-deposition of SiO_{y} and a luminescent compound onto the separating agent layer (a),
c) the separation of the luminescent SiO_{z} particles from the separating agent, in particular by dissolving the separating agent in a solvent, and
d) optionally separation of the luminescent SiO_{z} particles from the solvent.

If in the above process step a) is omitted and the carrier is replaced by a substrate material, a substrate material comprising a luminescent SiO_{z} film comprising a luminescent organic or inorganic compound can be prepared.

The term “halogen” means fluorine, chlorine, bromine and iodine.

C₁-C₂₅alkyl is typically linear or branched—where possible—methyl, ethyl, n-propyl, isopropyl, n-butyl, sec.-butyl, isobutyl, tert.-butyl, n-pentyl, 2-pentyl, 3-pentyl, 2,2-dimethylpropyl, n-hexyl, n-heptyl, n-octyl, 1,1,3,3-tetramethylbutyl and 2-ethylhexyl, n-nonyl, decyl, undecyl, dodecyl, tetradecyl, pentadecyl, hexadecyl, heptadecyl, octadecyl, eicosyl, heneicosyl, docosyl, tetracosyl or pentacosyl, preferably C₁-C₈alkyl such as methyl, ethyl, n-propyl, isopropyl, n-butyl, sec.-butyl, isobutyl, tert.-butyl, n-pentyl, 2-pentyl, 3-pentyl, 2,2-dimethylpropyl, n-hexyl, n-heptyl, n-octyl, 1,1,3,3-tetramethylbutyl and 2-ethylhexyl, more preferably C₁-C₄alkyl such as typically methyl, ethyl, n-propyl, isopropyl, n-butyl, sec.-butyl, isobutyl, tert.-butyl.

The terms “haloalkyl (or halogen-substituted alkyl), haloalkenyl and haloalkynyl” mean groups given by partially or wholly substituting the above-mentioned alkyl group, alkenyl group and alkynyl group with halogen, such as trifluoromethyl etc. The “aldehyde group, ketone group, ester group, carbamoyl group and amino group” include those substituted by an alkyl group, a cycloalkyl group, an aryl group, an aralkyl group or a heterocyclic group, wherein the alkyl group, the cycloalkyl group, the aryl group, the aralkyl group and the heterocyclic group may be unsubstituted or substituted. The term “silyl group” means a group of formula —SiR⁶²R⁶³R⁶⁴, wherein R⁶², R⁶³ and R⁶⁴ are independently of each other a C₁-C₈alkyl group, in particular a C₁-C₄alkyl group, a C₆-C₂₄aryl group or a C₇-C₁₂aralkyl group, such as a trimethylsilyl group. The term “siloxanyl group” means a group of formula —O—SiR⁶²R⁶³R⁶⁴, wherein R⁶², R⁶³ and R⁶⁴ are as defined above, such as a trimethylsiloxanyl group.

Examples of C₁-C₈alkoxy are methoxy, ethoxy, n-propoxy, isopropoxy, n-butoxy, sec.-butoxy, isobutoxy, tert.-butoxy, n-pentoxy, 2-pentoxy, 3-pentoxy, 2,2-dimethylpropoxy, n-hexoxy, n-heptoxy, n-octoxy, 1,1,3,3-tetramethylbutoxy and 2-ethylhexoxy, preferably C₁-C₄alkoxy such as typically methoxy, ethoxy, n-propoxy, isopropoxy, n-butoxy, sec.-butoxy, isobutoxy, tert.-butoxy. The term “alkylthio group” means the same groups as the alkoxy groups, except that the oxygen atom of ether linkage is replaced by a sulfur atom.

The term “aryl group” is typically C₆-C₂₄aryl, such as phenyl, 1-naphthyl, 2-naphthyl, 4-biphenyl, phenanthryl, terphenyl, pyrenyl, 2- or 9-fluorenyl or anthracenyl, preferably C₆-C₁₂aryl such as phenyl, 1-naphthyl, 2-naphthyl, 4-biphenyl, which may be unsubstituted or substituted.

The term “aralkyl group” is typically C₇-C₂₄aralkyl, such as benzyl, 2-benzyl-2-propyl, β-phenyl-ethyl, α,α-dimethylbenzyl, ω-phenyl-butyl, ω,ω-dimethyl-ω-phenyl-butyl, ω-phenyl-dodecyl, ω-phenyl-octadecyl, ω-phenyl-eicosyl or ω-phenyl-docosyl, preferably C₇-C₁₈aralkyl such as benzyl, 2-benzyl-2-propyl, β-phenyl-ethyl, α,α-dimethylbenzyl, ω-phenyl-butyl, ω,ω-dimethyl-ω-phenyl-butyl, ω-phenyl-dodecyl or ω-phenyl-octadecyl, and particularly preferred C₇-C₁₂aralkyl such as benzyl, 2-benzyl-2-propyl, β-phenyl-ethyl, α,α-dimethylbenzyl, ω-phenyl-butyl, or ω,ω-dimethyl-ω-phenyl-butyl, in which both the aliphatic hydrocarbon group and aromatic hydrocarbon group may be unsubstituted or substituted.

The term “aryl ether group” is typically a C₆₋₂₄aryloxy group, that is to say O—C₆₋₂₄aryl, such as, for example, phenoxy or 4-methoxyphenyl. The term “aryl thioether group” is typically a C₆₋₂₄arylthio group, that is to say S—C₆₋₂₄aryl, such as, for example, phenylthio or 4-methoxyphenylthio. The term “carbamoyl group” is typically a C₁-₁₈carbamoyl radical, preferably C₁₋₈carbamoyl radical, which may be unsubstituted or substituted, such as, for example, carbamoyl, methylcarbamoyl, ethylcarbamoyl, n-butylcarbamoyl, tert-butylcarbamoyl, dimethylcarbamoyloxy, morpholinocarbamoyl or pyrrolidinocarbamoyl.

The term “cycloalkyl group” is typically C₅-C₁₂cycloalkyl, such as cyclopentyl, cyclohexyl, cycloheptyl, cyclooctyl, cyclononyl, cyclodecyl, cycloundecyl, cyclododecyl, preferably cyclopentyl, cyclohexyl, cycloheptyl, or cyclooctyl, which may be unsubstituted or substituted. The term “cycloalkenyl group” means an unsaturated alicyclic hydrocarbon group containing one or more double bonds, such as cyclopentenyl, cyclopentadienyl, cyclohexenyl and the like, which may be unsubstituted or substituted. The cycloalkyl group, in particular a cyclohexyl group, can be condensed one or two times by phenyl which can be substituted one to three times with C₁-C₄-alkyl, halogen and cyano. Examples of such condensed cyclohexyl groups are: 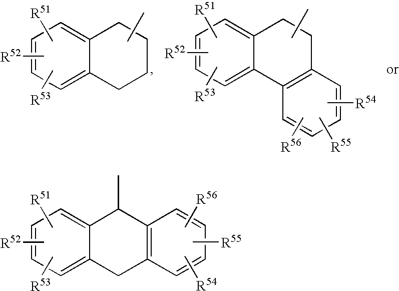
in particular 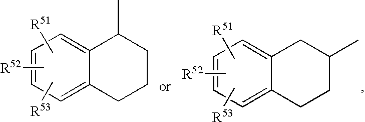
wherein R⁵¹, R⁵², R⁵³, R⁵⁴, R⁵⁵ and R⁵⁶ are independently of each other C₁-C₈-alkyl, C₁-C₈-alkoxy, halogen and cyano, in particular hydrogen.

The term “heteroaryl or heterocyclic group” is a ring with five to seven ring atoms, wherein nitrogen, oxygen or sulfur are the possible hetero atoms, and is typically an unsaturated heterocyclic radical with five to 18 atoms having at least six conjugated π-electrons such as thienyl, benzo[b]thienyl, dibenzo[b,d]thienyl, thianthrenyl, furyl, furfuryl, 2H-pyranyl, benzofuranyl, isobenzofuranyl, dibenzofuranyl, phenoxythienyl, pyrrolyl, imidazolyl, pyrazolyl, pyridyl, bipyridyl, triazinyl, pyrimidinyl, pyrazinyl, pyridazinyl, indolizinyl, isoindolyl, indolyl, indazolyl, purinyl, quinolizinyl, chinolyl, isochinolyl, phthalazinyl, naphthyridinyl, chinoxalinyl, chinazolinyl, cinnolinyl, pteridinyl, carbazolyl, carbolinyl, benzotriazolyl, benzoxazolyl, phenanthridinyl, acridinyl, perimidinyl, phenanthrolinyl, phenazinyl, isothiazolyl, phenothiazinyl, isoxazolyl, furazanyl or phenoxazinyl, preferably the above-mentioned mono- or bicyclic heterocyclic radicals.

The terms “aryl” and “alkyl” in alkylamino groups, dialkylamino groups, alkylarylamino groups, arylamino groups and diaryl groups are typically C₁-C₂₅alkyl and C₆-C₂₄aryl, respectively.

The above-mentioned groups can be substituted by a C₁-C₈alkyl, a hydroxyl group, a mercapto group, C₁-C₈alkoxy, C₁-C₈alkylthio, halogen, halo-C₁-C₈alkyl, a cyano group, an aldehyde group, a ketone group, a carboxyl group, an ester group, a carbamoyl group, an amino group, a nitro group, a silyl group or a siloxanyl group.

In a further embodiment of the present invention the organic luminescent compound is chemically bonded to the SiO_{z} flakes.

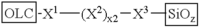

OLC means an organic luminescent compound, especially one of the organic luminescent compounds mentioned above and x2 is 0, or 1.

Suitably, the SiO_{z} bonding group X³ is derived from a reactive group, which can react under suitable conditions with a functional group of the SiO_{z} flakes.

Preferably, the functional group of the SiO_{z} flakes is a hydroxy group, and the reactive group X³ is derived from a group —Si(OR¹¹³)₂O—, wherein R¹¹³ is an H, or —OSi—.

Suitable spacer groups X² may contain 1-60 chain atoms selected from the group consisting of carbon, nitrogen, oxygen, sulphur and phosphorus.

For example, the spacer group may be:
—(CHR′)p-
{(CHR)q-O—(CHR′)r}s-
—{(CHR′)q-S—(CHR′)r}-
—{(CHR′)q-NR′—(CHR′)r}s-
—{(CHR′)q-Si(R′)₂—(CHR′)r}s-
—{(CHR′)q-(CH═CH)—(CHR′)r}s-
—{(CHR′)q-Ar—(CHR′)r}-
—{(CHR′)q-CO—NR′—(CHR′)r}s-
—{(CHR′)q-CO—Ar—NR′—(CHR′)r}s-,
   where R′ is hydrogen, C₁₋₄alkyl or aryl, which may be optionally substituted with sulphonate, Ar is phenylen, optionally substituted with sulphonate, p is 1-20, preferably 1-10, q is 1-10, r is 1-10 and s is 1-5.

X¹ is a group derived from the reaction of a reactive group of the colorant and a functional group bonded to the spacer group X², or vice versa.

The functional group is, for example, selected from succinimidyl ester, sulpho-succinimidyl ester, isothiocyanate, maleimide, haloacetamide, acid halide, vinylsulphone, dichlorotriazine, carbodiimide, hydrazide and phosphoramidite. Preferably, the reactive group of the colorant is a hydroxy group, or amino group.

Examples of possible reactive and functional groups are:

| Reactive Groups | Functional Groups |
|---|---|
| succinimidyl esters | primary amino, secondary amino, SH |
| isothiocyanates | amino groups, SH |
| isocyanates | amino groups, hydroxy, SH |
| haloacetamides | sulphydryl, hydroxy, amino |
| acid halides | amino groups, OH, SH |
| anhydrides | primary amino, secondary amino, hydroxy, |
| | SH |
| hydrazides | aldehydes, ketones |
| vinylsulphones | amino groups, hydroxy, SH |
| mono-, or dichlorotriazines | amino groups, SH |
| carbodiimides | carboxyl groups |
| halogenide | hydroxy, SH |

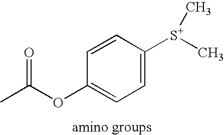

Accordingly, the group X¹ is selected from —NR¹¹⁴C(═O)—, —OC(═O)—, —SC(═O)—, —C(R¹¹⁴′)═N—NH—, —SO₂—CH₂—CH₂—O—, —SO₂—CH₂—CH₂—S—, —SO₂—CH₂—CH₂—NH—, 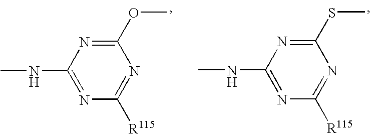
wherein R¹¹⁵ is chloro, substituted amino group, OH, or OR¹¹⁶, wherein R¹¹⁶ is C₁₋₄alkyl; —C(═O)NH—, —S—CH₂—C(═O)—NH—, —O—CH₂—C(═O)—NH—, or —NH—CH₂—C(═O)—NH—, —NH—C(═S)—NH—, —S—C(═S)—NH—, —NH—C(═O)—NH—, —S—C(═O)—NH—, —O—C(═O)—NH—, —NR¹¹⁴—, —S—, or —O—, wherein R¹¹⁴ is hydrogen, or C₁₋₈alkyl, and R^{114′} is hydrogen, or C₁₋₈alkyl.

Reactive groups which are especially useful for bonding luminescent materials with available amino and hydroxyl functional groups are preferred.

In a further aspect the present invention is directed to luminescent SiO_{z} flakes, especially luminescent porous SiO_{z} flakes, comprising an inorganic luminescent compound which is chemically bonded to the SiO_{z} flake via a group —X⁴—(X²)ₓ₂—X³—: 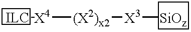
wherein x2 is 0, or 1, 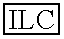
is an inorganic luminescent complex compound having a partial structure M-L-, wherein
M is a metal, especially a rare earth metal, very especially terbium (Tb), praeseodym (Pr), europium (Eu), lanthanide (La) and dysprosium (Dy), and L is a ligand which is chemically bonded to X⁴, or 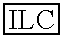
is an inorganic luminescent complex compound having a partial structure 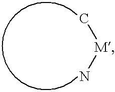
wherein
C—N is a cyclometallated ligand, which is chemically bonded to X⁴, M′ is a metal with an atomic weight of greater than 40, preferably of greater than 72,
X³ is a group —Si(OR¹¹³)₂O—, wherein R¹¹³ is H, or —OSi—,
X² is spacer group, especially
—(CHR′)p-
—{(CHR′)q-O—(CHR′)r}s-
—{(CHR′)q-S—(CHR′)r}-
—{(CHR′)q-NR′—(CHR′)r}s-
—{(CHR′)q-Si(R′)₂—(CHR′)r}s-
—{(CHR′)q-(CH═CH)—(CHR′)r}s-
—{(CHR′)q-Ar—(CHR′)r}-
—{(CHR′)q-CO—NR′—(CHR′)r}s-
—{(CHR′)q-CO—Ar—NR′—(CHR′)r}s-,
where R′ is hydrogen, C₁₋₄alkyl or aryl, which may be optionally substituted with sulphonate,
Ar is phenylen, optionally substituted with sulphonate, p is 1-20, preferably 1-10, q is 1-10, r is 1-10 and s is 1-5,
X⁴ is selected from —NR¹¹⁴C(═O)—, —OC(═O)—, —SC(═O)—, —C(R^{114′})═N—NH—, —SO₂—CH₂—CH₂—O—, —SO₂—CH₂—CH₂—S—, —SO₂—CH₂CH₂—NH—, 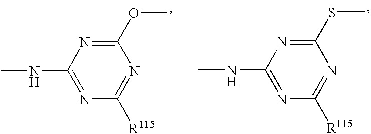
wherein R¹¹⁵ is chloro, substituted amino group, OH, or OR¹¹⁶, wherein R¹¹⁶ is C₁₋₄alkyl, —C(═O)NH—, —S—CH₂—C(═O)—NH—, —O—CH₂—C(═O)—NH—, or —NH—CH₂—C(═O)—NH—, —NH—C(═S)—NH—, —S—C(═S)—NH—, —NH—C(═O)—NH—, —S—C(═O)—NH—, —O—C(═O)—NH—, —NR¹¹⁴—, —S—, or —O—, wherein R¹¹⁴ is hydrogen, or C₁₋₈alkyl and R^{114′} is hydrogen, or C₁₋₈alkyl.

Examples of ligands, L, are 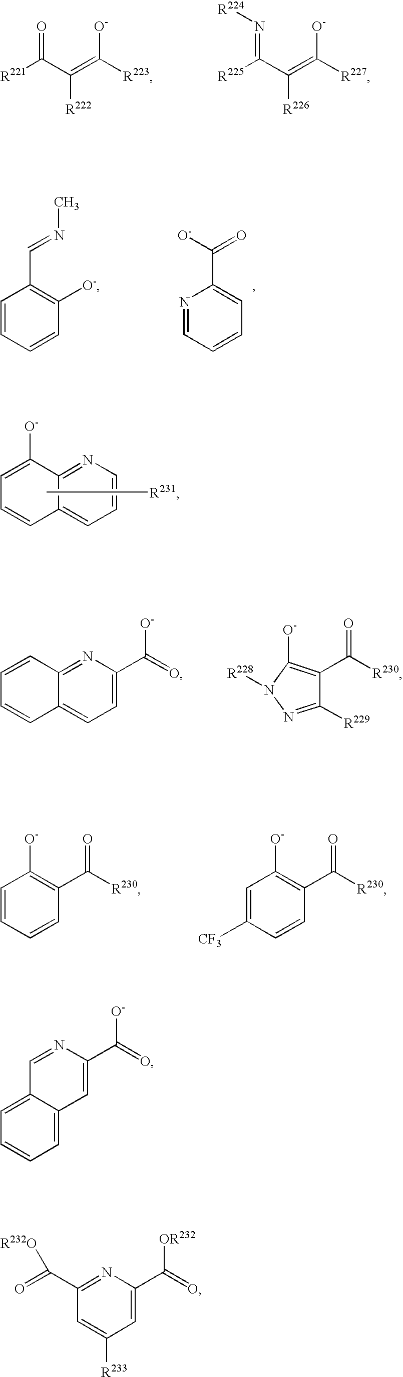 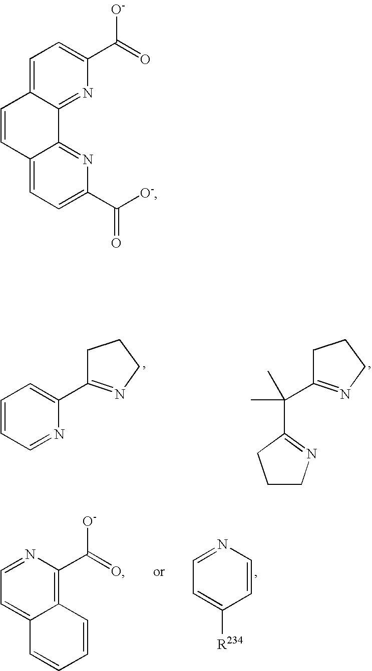
wherein
R²²¹ and R²²⁵ are independently of each other hydrogen, C₁-C₈alkyl, C₆-C₁₈aryl, C₂-C₁₀heteroaryl, or C₁-C₈perfluoroalkyl,
R²²² and R²²⁶ are independently of each other hydrogen, or C₁-C₈alkyl, and
R²²³ and R²²⁷ are independently of each other hydrogen, C₁-C₈alkyl, C₆-C₁₈aryl, C₂-C₁₀heteroaryl, C₁-C₈perfluoroalkyl, or C₁-C₈alkoxy, and
R²²⁴ is C₁-C₈alkyl, C₆-C₁₀aryl, or C₇-C₁₁aralkyl,
R²²⁸ is C₆-C₁₀aryl,
R²²⁹ is C₁-C₈alkyl,
R²³⁰ is C₁-C₈alkyl, or C₆-C₁₀aryl,
R²³¹ is hydrogen, C₁-C₈alkyl, or C₁-C₈alkoxy, which may be partially or fully fluorinated,
R²³² is C₁-C₈alkyl, C₆-C₁₀aryl, or C₇-C₁₁aralkyl,
R²³³ is a hydroxy group, Cl, or NH₂,
R²³⁴ is a primary or secondary amino group,
   with the proviso that one of the substituents R²²¹, R²²², R²²³, R²²⁵, R²²⁶, R²²⁷, R²²⁸, R²²⁹, R²³⁰, R²³¹, R²³³, or R²³⁴ bear or is a reactive group that can react with a functional group to form the group X⁴ or an additional residue bearing a reactive group is present that can react with a functional group to form the group X⁴.

In said aspect of the present invention the inorganic luminescent colorant is preferably a metal complex of formula 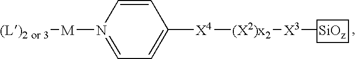
wherein M is terbium (Tb), praeseodym (Pr), europium (Eu), lanthanide (La) and dysprosium (Dy), especially Eu,
X⁴ is selected from —NR¹¹⁴C(═O)—, 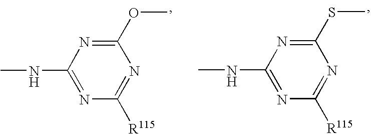
wherein R¹¹⁵ is chloro, substituted amino group, OH, or OR¹¹⁶, wherein R¹¹⁶ is C₁₋₄alkyl, —NH—CH₂—C(═O)—NH—, —NH—C(═S)—NH—, —NH—C(═O)—NH—, —NR¹¹⁴—, wherein R¹¹⁴ is hydrogen, or C₁₋₈alkyl, X², x2, and X³ are as defined above.

The ligands L′ are preferably derived from compounds HL′, 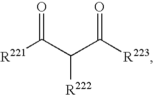
especially 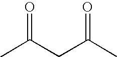
(2,4-pentanedionate [acac]), 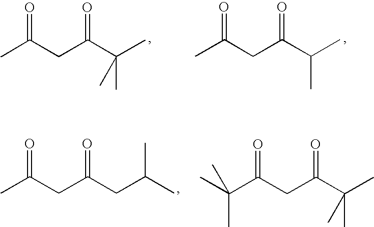
(2,2,6,6-tetramethyl-3,5-heptanedionate [TMH]), 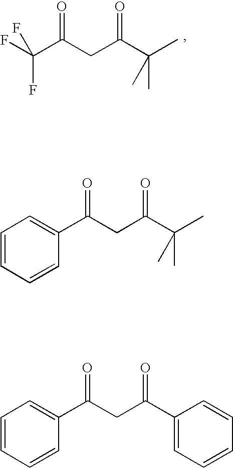
(1,3-diphenyl-1,3-propanedionate [DI]), 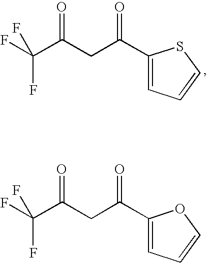
(4,4,4-trifluoro-1-(2-thienyl)-1,3-butanedionate [TTFA]), 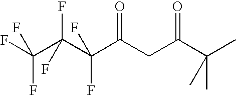
(7,7-dimethyl-1,1,1,2,2,3,3-heptafluoro-4,6-octanedionate [FOD]), 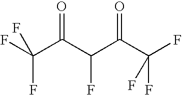
(1,1,1,3,5,5,5-heptafluoro-2,4-pentanedionate [F7acac]), 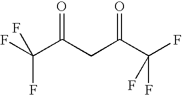
(1,1,1,5,5,5-hexafluoro-2,4-pentanedionate [F6acac]), 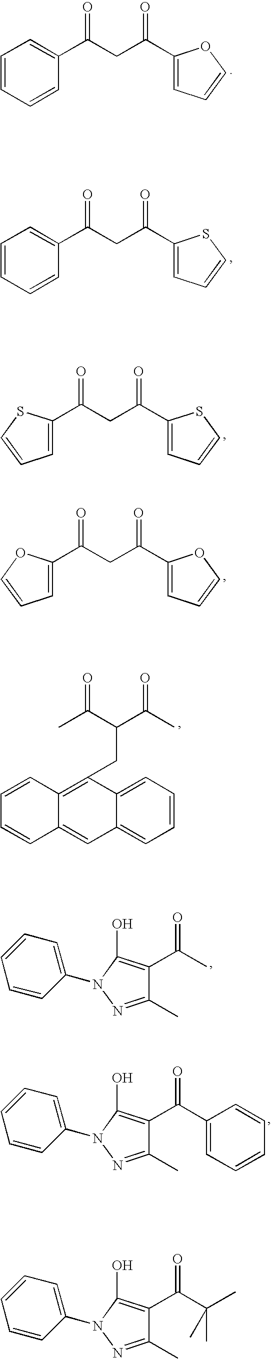
(1-phenyl-3-methyl-4-i-butyryl-pyrazolinonate [FMBP]),

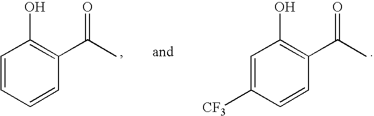

Suitable transition metals M′ include, but are not limited to Ir, Pt, Pd, Rh, Re, Os, Tl, Pb, Bi, In, Sn, Sb, Te, Au and Ag. Preferably the metal is selected from Ir, Rh and Re as well as Pt and Pd, wherein Ir is most preferred.

The cyclometallated ligand, C—N, may be selected from those known in the art. Preferred cyclometallating ligands are 2-phenylpyridines and phenylpyrazoles: 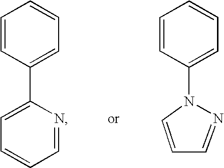
and derivatives thereof. The phenylpyridine or phenylpyrazole cyclometallated ligand may be optionally substituted with one or more alkyl, alkenyl, alkynyl, alkylaryl, CN, CF₃, CO₂R²⁵⁰, C(O)R²⁵⁰, N(R²⁵⁰)₂, NO₂, OR²⁵⁰, halo, aryl, heteroaryl, substituted aryl, substituted heteroaryl or a heterocyclic group, and additionally, or alternatively, any two adjacent substituted positions together form, independently, a fused 5- to 6-member cyclic group, wherein said cyclic group is cycloalkyl, cycloheteroalkyl, aryl, or heteroaryl, and wherein the fused 5- to 6-member cyclic group may be optionally substituted with one or more of alkyl, alkenyl, alkynyl, alkylaryl, CN, CF₃, CO₂R²⁵⁰, C(O)R²⁵⁰, N(R²⁵⁰)₂, NO₂, OR²⁵⁰, or halogen; and each R²⁵⁰ is independently alkyl, alkenyl, alkynyl, aralkyl, and aryl, with the proviso that the phenylpyridine or phenylpyrazole cyclometallated ligand bears a reactive group that can react with a functional group to form the group X⁴.

Cyclometallated ligand is a term well known in the art and includes but is not limited to 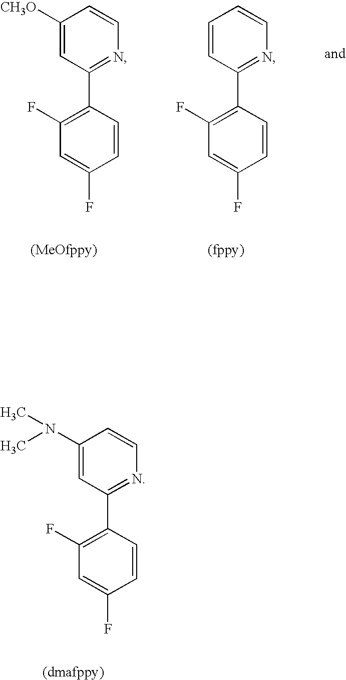
In said aspect of the present invention the inorganic luminescent colorant is preferably a metal complex of formula 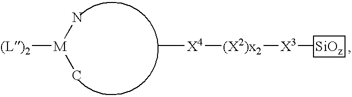
wherein L″ is L′, or a cyclometallated ligand, which is not chemically bonded to the SiO_{z} flakes.

For example, the SiO_{z} particles can firstly be modified by reaction with a functional silane, such as 3-mercaptopropyl trimethoxysilane. The porous SiO_{z} flakes have a high surface area and are mesoporous materials, i.e. have pore widths of ca. 1 to ca. 50 nm, especially 2 to 20 nm, wherein the pores are randomly inter-connected in a three-dimensional way. Isothiocyanate modified fluorescent dyes can enter and react with thiol groups inside the pores. The clear silicon oxide shells of controlled thicknesses protect fluorescent signals. The particles are stable and useful for many purposes, particularly for optical bar coding in combinatorial synthesis of polymers such as nucleic acid, polypeptide, and other synthesized molecules.

In a further aspect the present invention is directed to porous SiO_{z} flakes, comprising inorganic phosphors. The absorption of the exciting radiation is strongly dependent on the particle size of the phosphors and decreases rapidly for particles having relative high particle sizes. By using porous SiO_{z} flakes having pore sizes in the range of 1 to 50 nm, especially 2 to 20 nm, it is possible to produce nanosized phosphors within the pores of the porous SiO_{z} flakes.

I) Sulfides and Selenides

a) Zinc and Cadmium Sulfides and Sulfoselenides

The raw materials for the production of sulfide phosphors are high-purity zinc and cadmium sulfides, which are precipitated from purified salt solutions by hydrogen sulfide or ammonium sulfide. The Zn_{1-y}Cd_{y}S (0≦y≦0.3) can be produced by coprecipitation from mixed zinc-cadmium salt solutions.

The most important activators for sulfide phosphors are copper and silver, followed by manganese, gold, rare earths, and zinc. The charge compensation of the host lattice is effected by coupled substitution with mono- or trivalent ions (e.g., Cl⁻ or Al³⁺).

For the synthesis of phosphors, the sulfides are precipitated onto the porous SiO_{z} flakes with readily decomposed compounds of the activators and coactivators and are fired.

The luminescent properties can be influenced by the nature of the activators and coactivators, their concentrations, and the firing conditions. In addition, specific substitution of zinc or sulfur in the host lattice by cadmium or selenium is possible, which also influences the luminescent properties.

Doping zinc sulfide with silver (silver activation) leads to the appearance of an intense emission band in the blue region of the spectrum at 440 nm, which has a short decay time.

The substitution of zinc by cadmium in the ZnS:Ag phosphor leads to a shift of the emission maximum from the blue over to the green, yellow, red to the IR spectral region.

Activation with copper causes an emission in zinc sulfide which consists of a blue (460 nm) and a green band (525 nm) in varying ratios, depending on the preparation.

Zinc sulfide forms a wide range of substitutionally mixed crystals with manganese sulfide. Manganese-activated zinc sulfide has an emission band in the yellow spectral region at 580 nm.

The activation of zinc sulfide with gold leads to luminescence in the yellow-green (550 nm) or blue (480 nm) spectral regions, depending on the preparation, whereas a blue-white luminescing phosphor is formed on activation with phosphorus.

The activators are added in the form of oxides, oxalates, carbonates, or other compounds which readily decompose at higher temperatures.

b) Alkaline-Earth Sulfides and Sulfoselenides

Activated alkaline-earth metal sulfides have emission bands between the ultraviolet and near infrared. They are produced by precipitation of sulfates or selenites, optionally in the presence of activators, such as, for example, copper nitrate, manganese sulfate, or bismuth nitrate, onto the porous SiO_{z} flakes, followed by reduction with Ar—H₂ and firing. Alkaline-earth halides or alkali-metal sulfates are sometimes added as fluxes.

The alkaline-earth sulfides, such as MgS, or CaS, activated with rare earths, such as europium, cerium, or samarium, are of great importance:

CaS:Ce³⁺ is a green-emitting phosphor. On activation with 10⁻⁴ mol % cerium, the emission maximum occurs at 540 nm. Greater activator concentrations lead to a red shift; substitution of calcium by strontium, on the other hand, leads to a blue shift. MgS:Ce³⁺ (0.1%) has two emission bands in the green and red spectral regions at 525 and 590 nm; MgS:Sm³⁺ (0.1%) has three emission bands at 575 nm (green), 610 (red), and 660 nm (red).

Calcium or strontium sulfides, doubly activated with europium—samarium or cerium—samarium, can be stimulated by IR radiation. Emission occurs at europium or cerium and leads to orange-red (SrS:Eu²⁺, Sm³⁺) or green (CaS:Ce³⁺, Sm³⁺) luminescence.

c) Oxysulfides

The main emission lines of Y₂O₂S:Eu³⁺ occur at 565 and 627 nm. The intensity of the long-wavelength emission increases with the europium concentration, whereby the color of the emission shifts from orange to deep red. Terbium in Y₂O₂S has main emission bands in the blue (489 nm) and green spectral regions (545 and 587 nm), whose intensity ratio depends on the terbium concentration. At low doping levels, Y₂O₂S:Tb³⁺ luminesces blue-white, while at higher levels the color tends towards green. Gd₂O₂S:Tb³⁺ exhibits green luminescence.

II) Oxygen-Dominant Phosphors

a) Borates:

Sr₃B₁₂O₂₀F₂: Eu²⁺.

b) Aluminates:

Yttrium aluminate Y₃Al₅O₁₂:Ce³⁺ (YAG) is produced by precipitation of the hydroxides with NH₄OH onto the porous SiO_{z} flakes from a solution of the nitrates and subsequent firing.

Cerium magnesium aluminate (CAT) Ce_{0.65}Tb_{0.35}MgAl₁₁O₁₉ is produced by coprecipitation of the metal hydroxides onto the porous SiO_{z} flakes from a solution of the nitrates with NH₄OH and subsequent firing. A strongly reducing atmosphere is necessary to ensure that the rare earths are present as Ce³⁺ and Tb³⁺. Examples of further aluminate phosphors are BaMg₂Al₁₆O₂₇:Eu²⁺ and Y₂Al₃Ga₂O₁₂:Tb³⁺.

Long decay phosphors that are comprised of rare-earth activated divalent, boron-substituted aluminates are disclosed in U.S. Pat. No. 5,376,303. In particular, the long decay phosphors are comprised of MOₐ(Al_{1-b}B_{b})₂O₃:c R¹⁰³, wherein 0.5≦a≦10.0, 0.0001≦b≦0.5 and 0.0001≦c≦0.2, MO represents at least one divalent metal oxide selected from the group consisting of MgO, CaO, SrO and ZnO and R¹⁰³ represents Eu and at least one additional rare earth element. Preferably, R¹⁰³ represents Eu and at least one additional rare earth element selected from the group consisting of Pt, Nd, Dy and Tm.

c) Silicates

ZnSiO₄:Mn is used as a green phosphor. Its production involves the precipitation of a [Zn(NH₃)₄](OH)₂ and MnCO₃ solution onto the porous SiO_{z} flakes, which are subsequently dried and fired.

Yttrium orthosilicate Y₂SiO₅:Ce³⁺ can be produced by treating an aqueous solution of (Y, Tb) (NO₃)₃ with the SiO_{z} flakes, heating and by subsequent reductive firing under N₂/H₂. An yttrium orthosilicate can be doped with Ce, Tb, and Mn.

d) Germanates

Magnesium fluorogermanate, 3.5 MgO.0.5MgF₂.GeO₂:Mn⁴⁺ is a brilliant red phosphor.

e) Halophosphates and Phosphates

The halophosphates are doubly activated phosphors, in which Sb³⁺ and Mn²⁺ function as sensitizer and activator, giving rise to two corresponding maxima in the emission spectrum. The antimony acts equally as sensitizer and activator. The chemical composition can be expressed most clearly as 3Ca₃(PO₄)₂.Ca(F, Cl)₂:Sb³⁺, Mn²⁺.

The following phosphate phosphors are preferred: (Sr,Mg)₃(PO₄)₂:Sn²⁺; LaPO₄:Ce³⁺, Tb³⁺; Zn₃(PO₄)₂: Mn²⁺; Cd₅Cl(PO₄)₂:Mn²⁺; Sr₃(PO₄)₂.SrCl₂:Eu²⁺; and Ba₂P₂O₇:Ti⁴⁺.

3Sr₃(PO₄)₂.SrCl₂:Eu²⁺ can be excited by radiation from the entire UV range. The excitation maximum lies at 375 nm and the emission maximum at 447 nm. Upon successive substitution of Sr²⁺ by Ca²⁺ and Ba²⁺, the emission maximum shifts to 450 nm.

f) Oxides:

The preparation of Y₂O₃:Eu³⁺ is generally carried out by precipitating mixed oxalates from purified solutions of yttrium and europium nitrates onto the SiO_{z} flakes. Firing the dried oxalates is followed by crystallization firing.

Y₂O₃:Eu³⁺ shows an intense emission line at 611.5 nm in the red region. The luminescence of this red emission line increases with increasing Eu concentration up to ca. 10 mol %. Small traces of Tb can enhance the Eu fluorescence of Y₂O₃:Eu³⁺.

ZnO:Zn is a typical example of a self-activated phosphor.

g) Arsenates:

Magnesium arsenate 6MgO.As₂O₅:Mn⁴⁺ is a very brilliant red phosphor. Its production comprises the precipitation of magnesium and manganese onto the SiO_{z} flakes with pyroarsenic acid using solutions of MgCl₂ and MnCl₂. The dried precipitate is fired.

h) Vanadates

Of the vanadates activated with rare earths, YVO₄:Eu³⁺ are preferred, whereas vanadates with other activators (YVO₄ with Tm, Tb, Ho, Er, Dy, Sm, or In; GdVO₄:Eu; LuVO₄:Eu) are of less interest. The incorporation of Bi³⁺ sensitizes the Eu³⁺ emission and results in a shift of the luminescence color towards orange.

i) Sulfates:

Photoluminescent sulfates are obtained by activation with ions that absorb short-wavelength radiation, for example, Ce³⁺. Alkali-metal and alkaline-earth sulfates with Ce³⁺ emit between 300 and 400 nm. On additional manganese activation, the energy absorbed by Ce³⁺ is transferred to manganese with a shift of the emission into the green to red region. Water-insoluble sulfates are precipitated together with the activators onto the porous SiO_{z} flakes and fired below the melting point. In the case of activation by Ce³⁺ and Mn²⁺ the activator concentration is at least 0.5 mol %.

j) Tungstates and Molybdates

Magnesium tungstate MgWO₄ and calcium tungstate CaWO₄ are the most important self-activated phosphors. Magnesium tungstate has a high quantum yield of 84% for the conversion of the 50-270-nm radiation into visible light. On additional activation with rare-earth ions their typical emission also occurs. One Example of a molybdate activated with Eu³⁺ is Eu₂(WO₄)₃.

III) Halide Phosphors

Luminescent alkali-metal halides can be produced easily in high-purity and as large single crystals. Through the incorporation of foreign ions (e.g., Tl⁺, Ga⁺, In⁺) into the crystal lattice, further luminescence centers are formed. The emission spectra are characteristic for the individual foreign ions.

The porous SiO_{z} flakes comprising the alkali-metal halide phosphors are produced by firing the corresponding alkali-metal halide and the activator under an inert atmosphere.

Some important alkali-metal halide phosphors are listed in Table below:

| Host Crystal | Activator |
|---|---|
| LiI | Eu |
| NaI | Tl |
| CsI | Tl |
| CsI | Na |
| LiF | Mg |
| LiF | Mg, Ti |
| LiF | Mg, Na |

Of the alkaline-earth halide phosphors, those doped with manganese or rare earths are preferred, e.g., CaF₂:Mn; CaF₂:Dy.

They are produced by co-precipitation of CaF₂ and an activator from a solution of the corresponding cations onto the porous SiO_{z} flakes, followed by firing.

Other preferred halide phosphors are (Zn, Mg)F₂:Mn²⁺, KMgF₃:Mn²⁺, MgF₂:Mn²⁺, (Zn, Mg)F₂:Mn²⁺.

The oxyhalides of yttrium, lanthanum, and gadolinium are good host lattices for activation with other rare-earth ions such as terbium, cerium, and thulium, such as LaOCl:Tb³⁺ and LaOBr:Tb³⁺. The activator concentration (Tb, Tm) is 0.01-0.15 mol %. By coactivation, with ytterbium, the afterglow can be reduced. Partial substitution of lanthanum by gadolinium in LaOBr:Ce³⁺ leads to an increase in the quantum yield upon electron excitation and an increase in the quenching temperature.

The amount of luminescent compound, or composition in the SiO_{z} flakes can vary within wide limits and is advantageously in the range from 0.01 to 60% by weight, preferably more than 5% by weight to 50% by weight, based on total SiO_{z} flake mass. Preference is given to percentages ranging from 7 to 40%, by weight, based on total SiO_{z} flake mass.

Particularly preferred inorganic luminescent compounds produce a phosphorescence effect on excitation by visible or ultraviolet radiation. The phosphorescence effect has the advantage of being a simple way to ensure machine readability and of permitting the separation in space of the site of excitation from the site of detection. The phosphorescence effect may be excited even by white light, so that visual observation in a darkened environment is sufficient for detection. This facilitates the checking of any security coding of products, such as textiles, and the checking of documents of value.

The invention advantageously utilizes inorganic luminescent compounds which on excitation by visible or ultraviolet radiation in the wavelength range from 200 to 680 nm will, after the excitation has ended, emit visible light having spectral fractions in the wavelength range from 380 to 680 nm.

It is particularly advantageous to use zinc sulfides, zinc cadmium sulfides, alkaline earth metal aluminates, alkaline earth metal sulfides or alkaline earth metal silicates, all doped with one or more transition metal elements or lanthanoid elements. For instance, copper-doped zinc sulfides produce green phosphorescence, alkaline earth metal aluminates, alkaline earth metal sulfides or alkaline earth metal silicates doped with lanthanoid elements produce green, blue or red phosphorescence, and copper-doped zinc cadmium sulfides produce yellow, orange or red phosphorescence, depending on the cadmium content.

Preference is given to alkaline earth metal aluminates doped with europium and alkaline earth metal aluminates which, as well as europium, include a further rare earth element as coactivator, especially dysprosium. Particularly useful alkaline earth metal aluminates of the above-mentioned kind are described in EP-A-0 622 440 and U.S. Pat. No. 5,376,303, which are both incorporated herein in full by reference.

Natural teeth exhibit blue-white fluorescence with a characteristic spectral distribution through the action of long-wavelength UV light. Porous SiO_{z} flakes, comprising inorganic phosphors, such as yttrium silicates doped with cerium, terbium, and manganese give the artificial teeth made from it blue-white fluorescence in the long-wavelength UV. A typical composition is (Y_{0.937}Ce_{0.021}Tb_{0.033}Mn_{0.009})₂SiO₅. The excitation maximum of these phosphors is in the range 325-370 nm.

The luminescent SiO_{z} flakes according to the invention can be used for all customary purposes, for example for colouring polymers in the mass, coatings (including effect finishes, including those for the automotive sector) and printing inks (including offset printing, intaglio printing, bronzing and flexographic printing; see, for example, WO03/068868), and also, for example, for applications in cosmetics (see, for example, WO04/020530), in ink-jet printing (see, for example, WO04/035684), for dyeing textiles (see, for example, WO04/035911), glazes for ceramics and glass. Such applications are known from reference works, for example “Industrielle Organische Pigmente” (W. Herbst and K. Hunger, VCH Verlagsgesellschaft mbH, Weinheim/New York, 2nd, completely revised edition, 1995).

The luminescent SiO_{z} flakes according to the invention can be used with excellent results for pigmenting high molecular weight organic material.

The high molecular weight organic material for the pigmenting of which the pigments or pigment compositions according to the invention may be used may be of natural or synthetic origin. High molecular weight organic materials usually have molecular weights of about from 10³ to 10⁸ g/mol or even more. They may be, for example, natural resins, drying oils, rubber or cagein, or natural substances derived therefrom, such as chlorinated rubber, oil-modified alkyd resins, viscose, cellulose ethers or esters, such as ethylcellulose, cellulose acetate, cellulose propionate, cellulose acetobutyrate or nitrocellulose, but especially totally synthetic organic polymers (thermosetting plastics and thermoplastics), as are obtained by polymerisation, polycondensation or polyaddition. From the class of the polymerisation resins there may be mentioned, especially, polyolefins, such as polyethylene, polypropylene or polyisobutylene, and also substituted polyolefins, such as polymerisation products of vinyl chloride, vinyl acetate, styrene, acrylonitrile, acrylic acid esters, methacrylic acid esters or butadiene, and also copolymerisation products of the said monomers, such as especially ABS or EVA.

From the series of the polyaddition resins and polycondensation resins there may be mentioned, for example, condensation products of formaldehyde with phenols, so-called phenoplasts, and condensation products of formaldehyde with urea, thiourea or melamine, so-called aminoplasts, and the polyesters used as surface-coating resins, either saturated, such as alkyd resins, or unsaturated, such as maleate resins; also linear polyesters and polyamides, polyurethanes or silicones.

The said high molecular weight compounds may be present singly or in mixtures, in the form of plastic masses or melts. They may also be present in the form of their monomers or in the polymerised state in dissolved form as film-formers or binders for coatings or printing inks, such as, for example, boiled linseed oil, nitrocellulose, alkyd resins, melamine resins and urea-formaldehyde resins or acrylic resins.

A composition comprising a high molecular weight organic material and from 0.01 to 80% by weight, preferably from 0.1 to 30% by weight, based on the high molecular weight organic material, of the luminescent SiO_{z} flakes according to the invention is advantageous. Concentrations of from 1 to 20% by weight, especially of about 10% by weight, can often be used in practice.

The pigmenting of high molecular weight organic substances with the luminescent SiO_{z} flakes according to the invention is carried out, for example, by admixing such luminescent SiO_{z} flakes, where appropriate in the form of a masterbatch, with the substrates using roll mills or mixing or grinding apparatuses. The pigmented material is then brought into the desired final form using methods known per se, such as calendering, compression moulding, extrusion, coating, pouring or injection moulding. Any additives customary in the plastics industry, such as plasticisers, fillers or stabilisers, can be added to the polymer, in customary amounts, before or after incorporation of the pigment. In particular, in order to produce non-rigid shaped articles or to reduce their brittleness, it is desirable to add plasticisers, for example esters of phosphoric acid, phthalic acid or sebacic acid, to the high molecular weight compounds prior to shaping.

For pigmenting coatings and printing inks, the high molecular weight organic materials and the luminescent SiO_{z} flakes according to the invention, where appropriate together with customary additives such as, for example, fillers, other pigments, siccatives or plasticisers, are finely dispersed or dissolved in the same organic solvent or solvent mixture, it being possible for the individual components to be dissolved or dispersed separately or for a number of components to be dissolved or dispersed together, and only thereafter for all the components to be brought together.

Dispersing the luminescent SiO_{z} flakes according to the invention in the high molecular weight organic material being pigmented, and processing a pigment composition according to the invention, are preferably carried out subject to conditions under which only relatively weak shear forces occur so that the flakes are not broken up into smaller portions.

Plastics comprising the luminescent SiO_{z} flakes of the invention in amounts of 0.1 to 50% by weight, in particular 0.5 to 7% by weight. In the coating sector, the pigments of the invention are employed in amounts of 0.1 to 10% by weight. In the pigmentation of binder systems, for example for paints and printing inks for intaglio, offset or screen printing, the pigment is incorporated into the printing ink in amounts of 0.1 to 50% by weight, preferably 5 to 30% by weight and in particular 8 to 15% by weight.

The luminescent SiO_{z} flakes according to the invention are also suitable for making-up the lips or the skin and for colouring the hair or the nails.

The invention accordingly relates also to a cosmetic preparation or formulation comprising from 0.0001 to 90% by weight of the luminescent SiO_{z} flakes, according to the invention and from 10 to 99.9999% of a cosmetically suitable carrier material, based on the total weight of the cosmetic preparation or formulation.

Such cosmetic preparations or formulations are, for example, lipsticks, blushers, foundations, nail varnishes and hair shampoos.

The cosmetic preparations and formulations according to the invention preferably contain the pigment according to the invention in an amount from 0.005 to 50% by weight, based on the total weight of the preparation.

Suitable carrier materials for the cosmetic preparations and formulations according to the invention include the customary materials used in such compositions.

The cosmetic preparations and formulations according to the invention may be in the form of, for example, sticks, ointments, creams, emulsions, suspensions, dispersions, powders or solutions. They are, for example, lipsticks, mascara preparations, blushers, eye-shadows, foundations, eyeliners, powder or nail varnishes.

In addition, the luminescent SiO_{z} flakes of the present invention can be used as substrates of interference pigments which have luminescent and color-shifting properties. The layer structure of such interference pigment flakes is described in more detail in WO04/065295. The interference pigment flakes exhibit a discrete color shift so as to have a first color at a first angle of incident light or viewing and a second color different from the first color and a second angle of incident light or viewing. The interference pigment flakes can be interspersed into liquid media such as paints or inks to produce colorant materials for subsequent application to objects or papers.

The luminescent color-shifting pigment flakes are particularly suited for use in applications where colorants of high chroma and durability are desired. By using the luminescent color-shifting pigment flakes in a colorant material, high chroma durable paint or ink can be produced in which variable color effects are noticeable to the human eye. The luminescent color-shifting flakes of the invention have a wide range of color-shifting properties, including large shifts in chroma (degree of color purity) and also large shifts in hue (relative color) with a varying angle of view. Thus, an object colored with a paint containing the luminescent colorshifting flakes of the invention will change color depending upon variations in the viewing angle or the angle of the object relative to the viewing eye.

The luminescent color-shifting flakes of the invention can be easily and economically utilized in paints and inks which can be applied to various objects or papers, such as motorized vehicles, currency and security documents, household appliances, architectural structures, flooring, fabrics, sporting goods, electronic packaging/housing, product packaging, etc. The luminescent color-shifting flakes can also be utilized in forming colored plastic materials, coating materials, extrusions, electrostatic coatings, glass, and ceramic materials.

In order to obtain an optimum optical effect, it should be ensutred during processing that the platelet-shaped pigment is well oriented, i.e. is aligned as parallel as possible to the surface of the respective medium. This parallel orientation of the pigment particles is best carried out from a flow process, and is generally achieved in all known methods of plastic processing, painting, coating and printing.

Owing to its uncopyable optical effects, the luminescent SiO_{z} flakes according to the invention are preferably used for the production of forgery-proof materials from paper and plastic. In addition, the pigment according to the invention can also be used in formulations such as paints, printing inks, varnishes, in plastics, ceramic materials and glasses, in cosmetics, for laser marking of paper and plastics and for the production of pigment preparations in the form of pellets, chips, granules, briquettes, etc.

The term forgery-proof materials made from paper is taken to mean, for example, documents of value, such as banknotes, cheques, tax stamps, postage stamps, rail and air tickets, lottery tickets, gift certificates, entry cards, forms and shares. The term forgery-proof materials made from plastic is taken to mean, for example, cheque cards, credit cards, telephone cards and identity cards.

For the production of printing inks, the luminescent SiO_{z} flakes are incorporated into binders which are usually suitable for printing inks. Suitable binders are cellulose, polyacrylate-polymethacrylate, alkyd, polyester, polyphenol, urea, melamine, polyterpene, polyvinyl, polyvinyl chloride and polyvinylpyrrolidone resins, polystyrenes, polyolefins, coumarone-indene, hydrocarbon, ketone, aldehyde and aromatic-formaldehyde resins, carbamic acid, sulfonamide and epoxy resins, polyurethanes and/or natural oils, or derivatives of the said substances.

Besides the film-forming, polymeric binder, the printing ink comprises the conventional constituents, such as solvents, if desired water, antifoams, wetting agents, constituents which affect the rheology, antioxidants, etc.

The luminescent SiO_{z} flakes according to the invention can be employed for all known printing processes. Examples thereof are gravure printing, flexographic printing, screen printing, bronze printing and offset printing.

Since all known plastics can be pigmented with pearlescent pigments, the production of forgery-proof materials from plastic is not limited by the use of the luminescent SiO_{z} flakes according to the invention. It is suitable for all mass colourings of thermoplastics and thermosetting plastics and for the pigmentation of printing inks and varnishes for surface finishing thereof. The pigment according to the invention can be used for pigmenting acrylonitrile-butadiene-styrene copolymers, cellulose acetate, cellulose acetobutyrate, cellulose nitrate, cellulose propionate, artificial horn, epoxy resins, polyamide, polycarbonate, polyethylene, polybutylene terephthalate, polyethylene terephthalate, polymethyl methacrylate, polypropylene, polystyrene, polytetrafluoroethylene, polyvinyl chloride, polyvinylidene chloride, polyurethane, styrene-acrylonitrile copolymers and unsaturated polyester resins.

The Examples that follow illustrate the invention without limiting the scope thereof. Unless otherwise indicated, percentages and parts are percentages and parts by weight, respectively.

### EXAMPLE 1

a) Diethyl-4-hydroxypyridine-2,6-dicarboxylate 1 was prepared in 64% yield by treatment of 7.0 g (34.8 mmol) chelidamic acid—monohydrate with 15 ml (325 mmol) absolute ethanol and 10 g toluenesulfonic acid in 330 ml CHCl₃ at reflux in analogy to a published procedure (Inorg. Chem. 2000, Vol. 39, No. 21, 4678-4687).

Found: C: 55.15; H: 5.46; N: 5.77. Calc. for C₁₁H₁₃NO₅: C: 55.23; H: 5.48; N: 5.24% ¹H-NMR (DMSO-d₆): δ 1.33 (t, 6H), 4.36 (q, 4H), 7.58 (s, 2H)

b) 3-Bromopropyl-modified porous SiO_{z} 2

1.0 g of porous SiO_{z} (z≈1.4-1.6) obtained in analogy to example 1 of WO04/065295 are suspended in 100 ml absolute ethanol. Under nitrogen a solution of 2.82 ml (3.65 g) 3-bromopropyltrimethoxysilane in 25 ml absolute ethanol is added dropwise with continued stirring. The suspension is stirred for 1 hour, then heated to 50° C. and stirred for 22 hours at 50° C. The cooled suspension is filtered, washed with absolute ethanol and the residue is dried at 60° C. in vacuo. Yield: 0.99 g. Elemental analysis shows an organic shell proportion of w(C₃H₆Br)=1.5%.

c) Diethyl-4-propyloxypyridine-2,6-dicarboxylate-modified porous SiO_{z} 3

2.39 g (10 mmol) of 1 and 0.69 g (5 mmol) K₂CO₃ are suspended in 70 ml of DMF under nitrogen with stirring. After 1 hour of continued stirring 0.85 g of 2 are added with stirring at room temperature. The suspension is heated to 75° C. for 16 hours with continued stirring. After cooling the suspension is filtered, washed successively with DMF, de-ionized water and methanol and the residue is dried at 60° C. in vacuo. Yield: 0.81 g. Elemental analysis shows an organic shell proportion of w(C₁₄H₁₈NO₅)=2.6%

d) 0.2 g (0.5 mmol) EuCl₃.6H₂O are diluted in 30 ml of de-ionized water and the solution is adjusted to pH=6. 0.32 g of 3 are added and the suspension is stirred for 65 hours at pH=6. The suspension is filtered, washed repeatedly with de-ionized water and the residue is dried at 80° C. in vacuo. Yield: 0.30 g. Elemental analysis shows a Eu content of 3.67% wt and an organic shell proportion of w(C₁₄H₁₈NO₅)=2.0%.

### EXAMPLE 2

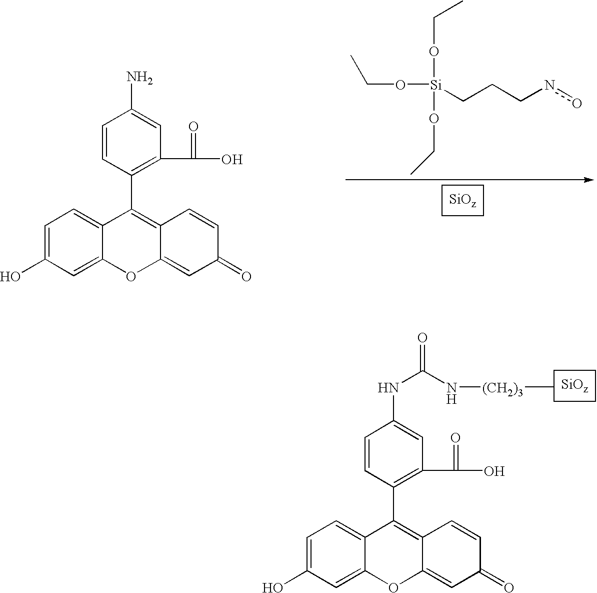

52.4 mg (3-triethoxysilyl)propylisocyanate are added to 50 mg 4′-aminofluorescein in 8 ml DMF and stirred until termination of the reaction. The reaction mixture is filtered. Porous SiO_{z} flakes (z≈1.4-1.6) obtained in analogy to example 1 of WO04/065295 are added to the obtained yellow DMF solution. The suspension is stirred for 1 hour, then heated to 50° C. and stirred for 22 hours at 50° C. The cooled suspension is filtered, washed with absolute ethanol and the residue is dried at 60° C. in vacuo.

### EXAMPLE 3

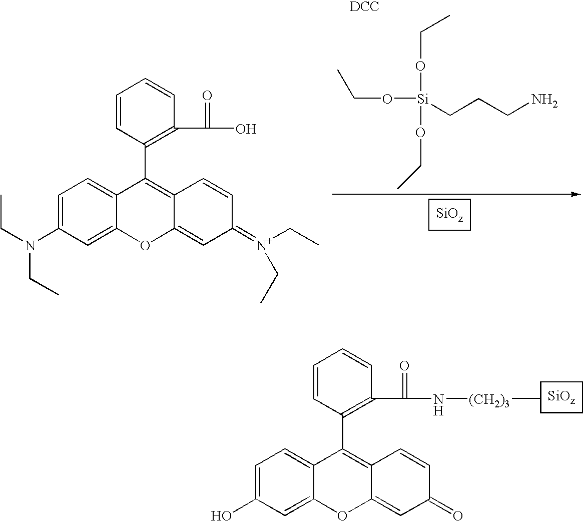

40 μl concentrated HCl are added to 50 mg Rhodamin B base in 1 ml water. The mixture is evaporated to dryness. 5 ml CH₂Cl₂ are added to the residue. 23.3 mg dicyclohexylcarbodiimide (DCC) and 20.3 mg (3-aminopropyl)trimethoxysilane are added, the reaction mixture is stirred until termination of the reaction and then filtered. Porous SiO_{z} flakes (z≈1.4-1.6) obtained in analogy to example 1 of WO04/065295 are added to the obtained red CH₂Cl₂ solution. The suspension is stirred for 1 hour, then heated to 50° C. and stirred for 22 hours at 50° C. The cooled suspension is filtered, washed with absolute ethanol and the residue is dried at 60° C. in vacuo.

### EXAMPLE 4

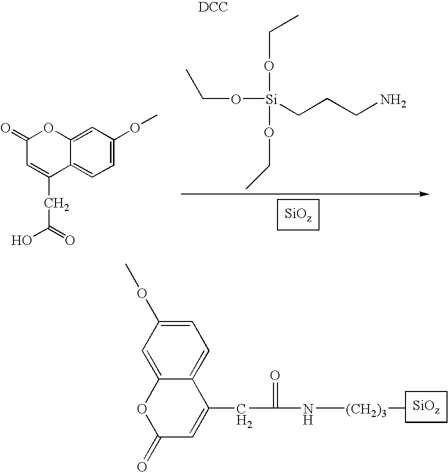

50 mg 7-methoxycoumarin-4-acetic acid are added to 4 ml dioxane. 44 mg dicyclohexylcarbodiimide (DCC) and 38.3 mg (3-aminopropyl)trimethoxysilane are added, the reaction mixture is stirred until termination of the reaction and then filtered. Porous SiO_{z} flakes (z≈1.4-1.6) obtained in analogy to example 1 of WO04/065295 are added to the obtained red dioxane solution. The suspension is stirred for 1 hour, then heated to 50° C. and stirred for 22 hours at 50° C. The cooled suspension is filtered, washed with absolute ethanol and the residue is dried at 60° C. in vacuo.

### EXAMPLE 5

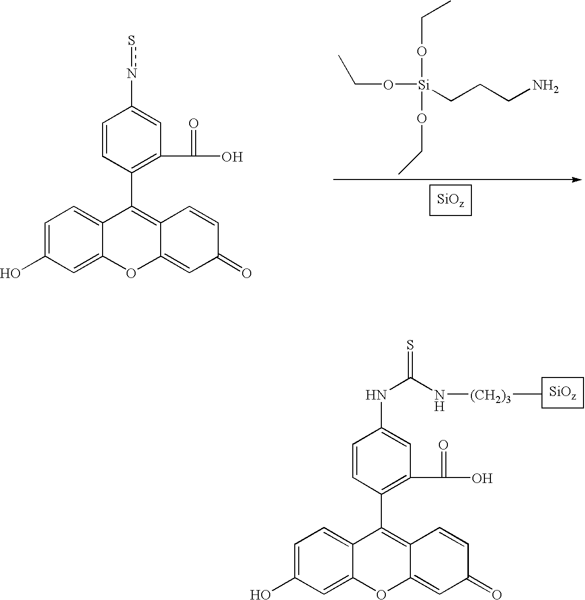

5 mg of porous silicon oxide particles modified by reaction with 3-aminopropyl trimethoxysilane are placed in a vial and a solution of ethanol (500 microliters) and fluorescein isothiocyanate (1 milligram) are added. The colorant solution was removed from the vial after the reaction has been terminated. The particles are washed in ethanol five 15 times. The vial was then placed in an ultrasonic bath for one hour, and the particles washed 3 times.

The amount of colorant incorporated into the particle is controlled by allowing the colorant to absorb into the particle for different periods of time. The colorants were firmly attached to the particles.

### EXAMPLE 6

### Y₂O₃:Eu in porous SiO_{z}

1.0 g (3.6 mmol) of Y(NO₃)₃ and 0.134 g (0.36 mmol) EuCl₃-hexahydrate are diluted in 50 ml of de-ionised water. 1 g of porous SiO_{z} (BET: 647 m²/g, z≈1.74) is added to this solution while stirring. After 3 hours a solution of 9.0 g of urea in 50 ml de-ionised water is added with stirring at room temperature. The suspension is heated to 100° C. for 6 hours with continued stirring. After cooling the suspension is filtered through a cotton sieve, washed with de-ionised water, the residue is dried at 80° C. in vacuo and subsequently fired at 900° C. for 14 hours, followed by 1000° C. for 3 hours. Yield: 1.19 g. The BET surface area dropped to 268 m²/g after filling the pores with Y₂O₃:Eu and to 186 m²/g after firing. The compound shows a red fluorescence at 611 nm with an excitation wavelength of 254 nm.

### EXAMPLE 7

### EU₂(WO₄)₃ in porous SiO_{z}

2.0 g Na₂WO₄.2H₂O are diluted in 10 ml de-ionized water. 1.2 g of porous SiO_{z} (BET: 773 m²/g) are added while stirring. After 4 h of stirring the suspension is filtered and the residue is dried at 80° C. in vacuo. The product is redispersed in dried ethanol using ultrasound. A solution of 0.5 g EuCl₃ in dried ethanol is slowly added. The suspension is filtered, washed successively with ethanol, ethanol/water 1:1, water and finally ethanol, and the residue is dried at 60° C. in vacuo. Subsequently the product is optionally fired at 600° C. The received compound shows a pore loading of 14% wt. Eu₂(WO₄)₃ and exhibits a strong red fluorescence at an excitation wavelength of 254 nm.

### EXAMPLE 8

### Fluorescent Organic Pigment,

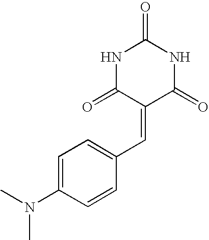

### and Dimer, in Porous SiO_{z}

5.0 g barbituric acid is diluted in 250 ml formic acid. 5.0 g of porous SiO_{z} flakes (BET: 712 m²/g) are added while stirring. After 18 h of stirring the suspension is filtered and the residue is dried at 120° C. in vacuo for 20 hours. The product is redispersed in 160 ml ethanol, 0.1 g triethylamine is added and the mixture is heated to 78° C. A solution of 1.5 g dimethylaminobenzaldehyd in ethanol using a heatable dropping funnel at 65° C. is slowly added while stirring. The suspension is stirred for 75 minutes, cooled, filtered, washed successively with ethanol and water, and the residue is dried at 100° C. in vacuo. The received compound shows a pore loading of 9% by weight of the fluorescent pigment and exhibits a red fluorescence at an excitation wavelength of 254 nm.

1. A non-porous or porous SiO_{z} flake, wherein 0.70≦z≦2.0, comprising an organic or inorganic luminescent compound or composition.

2. The porous SiO_{z} flake according to claim 1, wherein the luminescent compound, or composition comprises a fluorescent organic colorant which is selected from coumarins, benzocoumarins, xanthenes, benzo[a]xanthenes, benzo[b]xanthenes, benzo[c]xanthenes, phenoxazines, benzo[a]phenoxazines, benzo[b]phenoxazines and benzo[c]phenoxazines, napthalimides, naphtholactams, azlactones, methines, oxazines and thiazines, diketopyrrolopyrroles, perylenes, quinacridones, benzoxanthenes, thio-epindolines, lactamimides, diphenylmaleimides, acetoacetamides, imidazothiazines, benzanthrones, perylenmonoimides, perylenes, phthalimides, benzotriazoles, pyrimidines, pyrazines, triazoles, dibenzofurans and triazines.

3. The porous SiO_{z} flake according to claim 2, wherein the luminescent compound is selected from
Xanthene colorants of formula 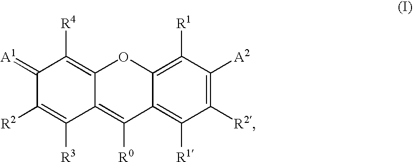
wherein A′ represents O or N-Z in which Z is H or C₁-C₈alkyl, or is optionally combined with R², or R⁴ to form a 5- or 6-membered ring, or is combined with each of R² and R⁴ to form two fused 6-membered rings; A² represents —OH or —NZ₂; R¹, R^{1′}, R², R^{2′}, R³ and R⁴ are each independently selected from H, halogen, cyano, CF₃, C₁-C₈alkyl, C₁-C₈alkylthio, C₁-C₈alkoxy, aryl and heteroaryl; wherein the alkyl portions of any of R^{1′}, R^{2′} or R¹ through R⁴ are optionally substituted with halogen, carboxy, sulfo, amino, mono- or dialkylamino, alkoxy, cyano, haloacetyl or hydroxy; and the aryl or heteroaryl portions of any of R^{1′}, R^{2′} or R¹ through R⁴ are optionally substituted with from one to four substituents selected from the group consisting of halogen, cyano, carboxy, sulfo, hydroxy, amino, mono- or di(C₁-C₈)alkylamino, C₁-C₈alkyl, C₁-C₈alkylthio and C₁-C₈alkoxy; R⁰ is halogen, cyano, CF₃, C₁-C₈alkyl, C₁-C₈alkenyl, C₁-C₈alkynyl, aryl or heteroaryl having the formula: 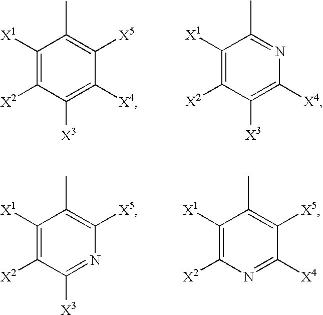
wherein X¹, X², X³, X⁴ and X⁵ are each independently selected from the group consisting of H, halogen, cyano, CF₃, C₁-C₈alkyl, C₁-C₈alkoxy, C₁-C₈alkylthio, C₁-C₈alkenyl, C₁-C₈alkynyl, SO₃H and CO₂H, wherein, additionally, the alkyl portions of any of X¹ through X⁵ can be further substituted with halogen, carboxy, sulfo, amino, mono- or dialkylamino, alkoxy, cyano, haloacetyl or hydroxy, and, optionally, any two adjacent substituents X¹ through X⁵ can be taken together to form a fused aromatic ring that is optionally further substituted with from one to four substituents selected from halogen, cyano, carboxy, sulfo, hydroxy, amino, mono- or di(C₁-C₈) alkylamino, (C₁-C₈)alkyl, (C₁-C₈)alkylthio and (C₁-C₈)alkoxy;
Benzo[a]xanthen colorants of formula 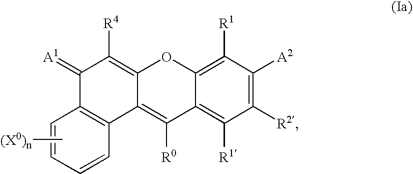
wherein
n is an integer of 0 to 4,
each X⁰ is independently selected from the group consisting of H, halogen, cyano, CF₃, C₁-C₈alkyl, C₁-C₈alkoxy, C₁-C₈alkylthio, C₁-C₈alkenyl, C₁-C₈alkynyl, aryl, heteroaryl, SO₃H and CO₂H;
A¹, A², R⁰, R¹, R^{1′}, R^{2′}, and R⁴ are as defined above, wherein the alkyl portions of X⁰ can be further substituted with halogen, carboxy, sulfo, amino, mono- or dialkylamino, alkoxy, cyano, haloacetyl or hydroxy, and the aryl or heteroaryl portions of any of R¹, R^{1′}, R^{2′}, and R⁴ are optionally substituted with from one to four substituents selected from the group consisting of halogen, cyano, carboxy, sulfo, hydroxy, amino, mono- or di(C₁-C₈)alkylamino, C₁-C₈alkyl, C₁-C₈alkylthio and C₁-C₈alkoxy;
Benzo[b]xanthen colorants of formula 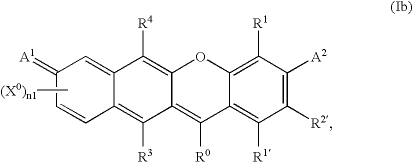
wherein
n1 is an integer of 0 to 3, X⁰, A¹, A², R⁰, R¹, R^{1′}, R^{2′}, R³ and R⁴ are as defined above;
Benzo[b]xanthen colorants of formula 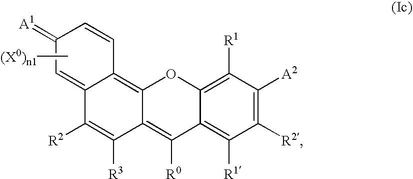
wherein
n1 is an integer of 0 to 3, X⁰, A¹, A², R⁰, R¹, R^{1′}, R^{2′}, R² and R³ are as defined above;
Coumarin colorants of formula 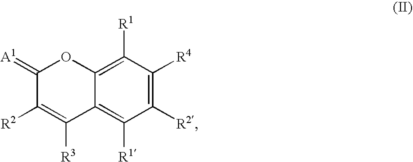
wherein A¹, R¹, R^{1′}, R^{2′}, R², R³, and R⁴ are as defined above, or R² and R³ are independently of each other of halogen, cyano, CF₃, C₁-C₈alkyl, aryl, or heteroaryl having the formula 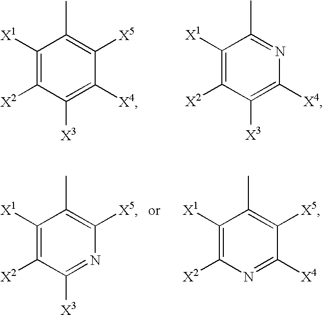
wherein X¹, X², X³, X⁴ and X⁵ are as defined above, or R² and R³ are combined to form a fused benzene ring, optionally substituted with one to four substituents selected from halogen cyano, carboxy, sulfo, hydroxy, amino, mono- or di(C₁-C₈)alkylamino, C₁-C₈alkyl, C₁-C₈alkylthio and C₁-C₈alkoxy; 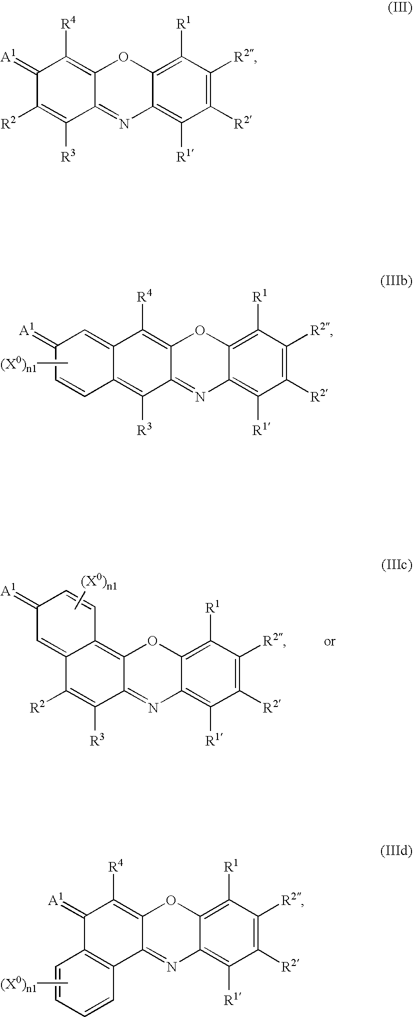
wherein R^{2″}has the meanings provided above for R^{2′}, n1, X⁰, A¹, R¹, R^{1′}, R^{2′}, R², R³ and R⁴ are as defined above.

4. The porous SiO_{z} flake according to claim 2, wherein the luminescent compound is selected from a compound of formula 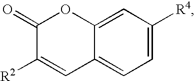
wherein R⁴ is —N(C₂H₅)₂ and R² is a group of formula: 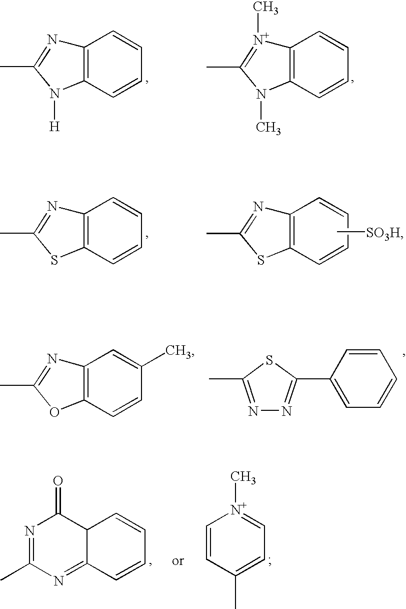
a compound of formulae 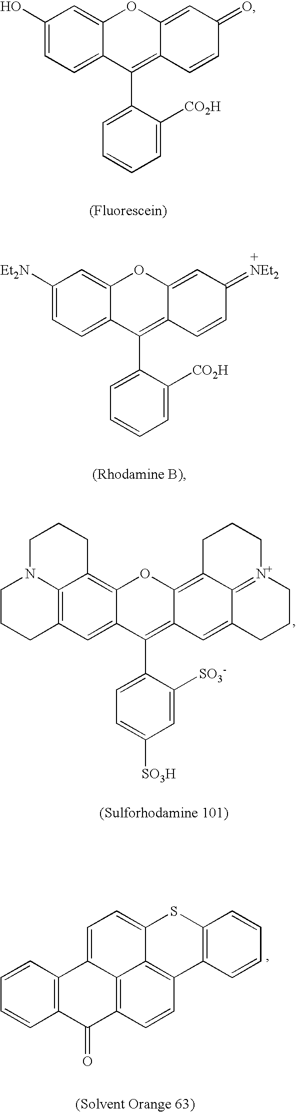 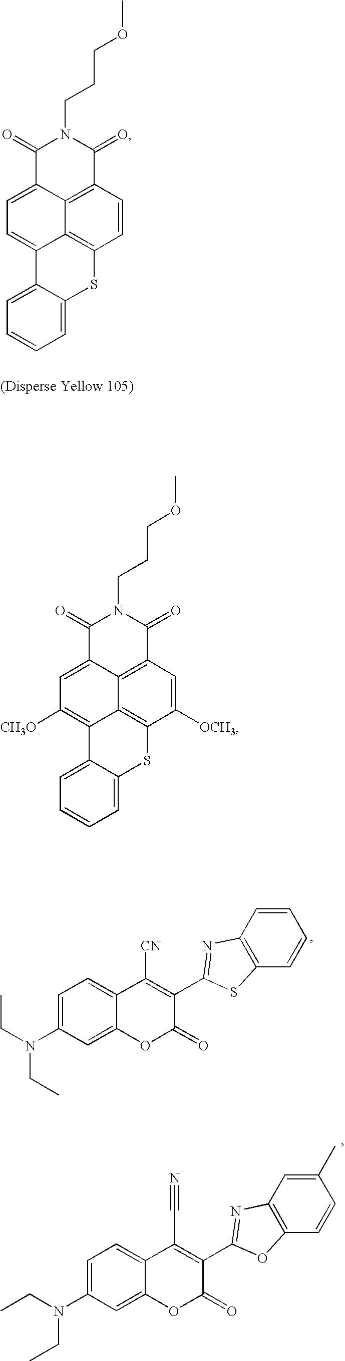 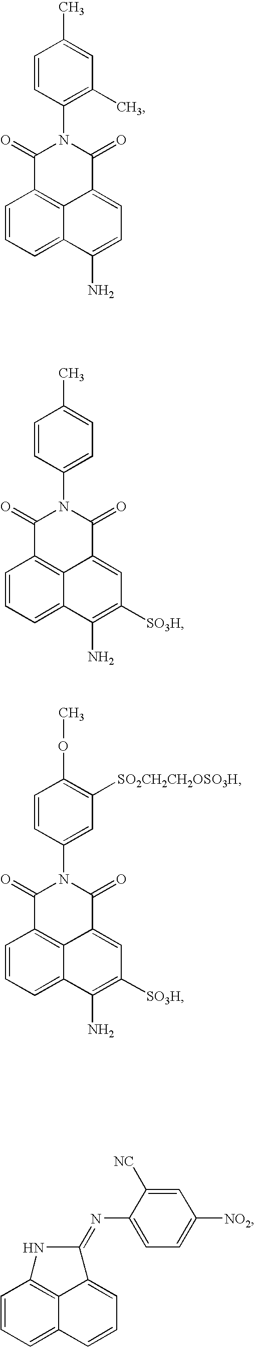 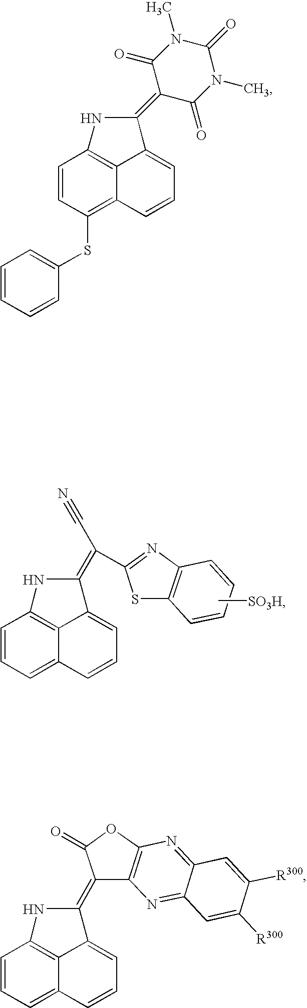
wherein R³⁰⁰ is H, C₁-C₈alkyl, or C₁-C₈alkoxy; 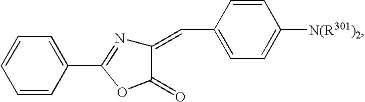
wherein R³⁰¹ is C₁-C₈alkyl; 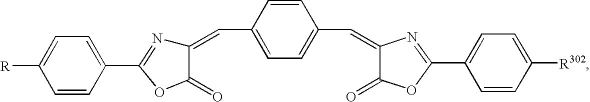
wherein R³⁰² is H, 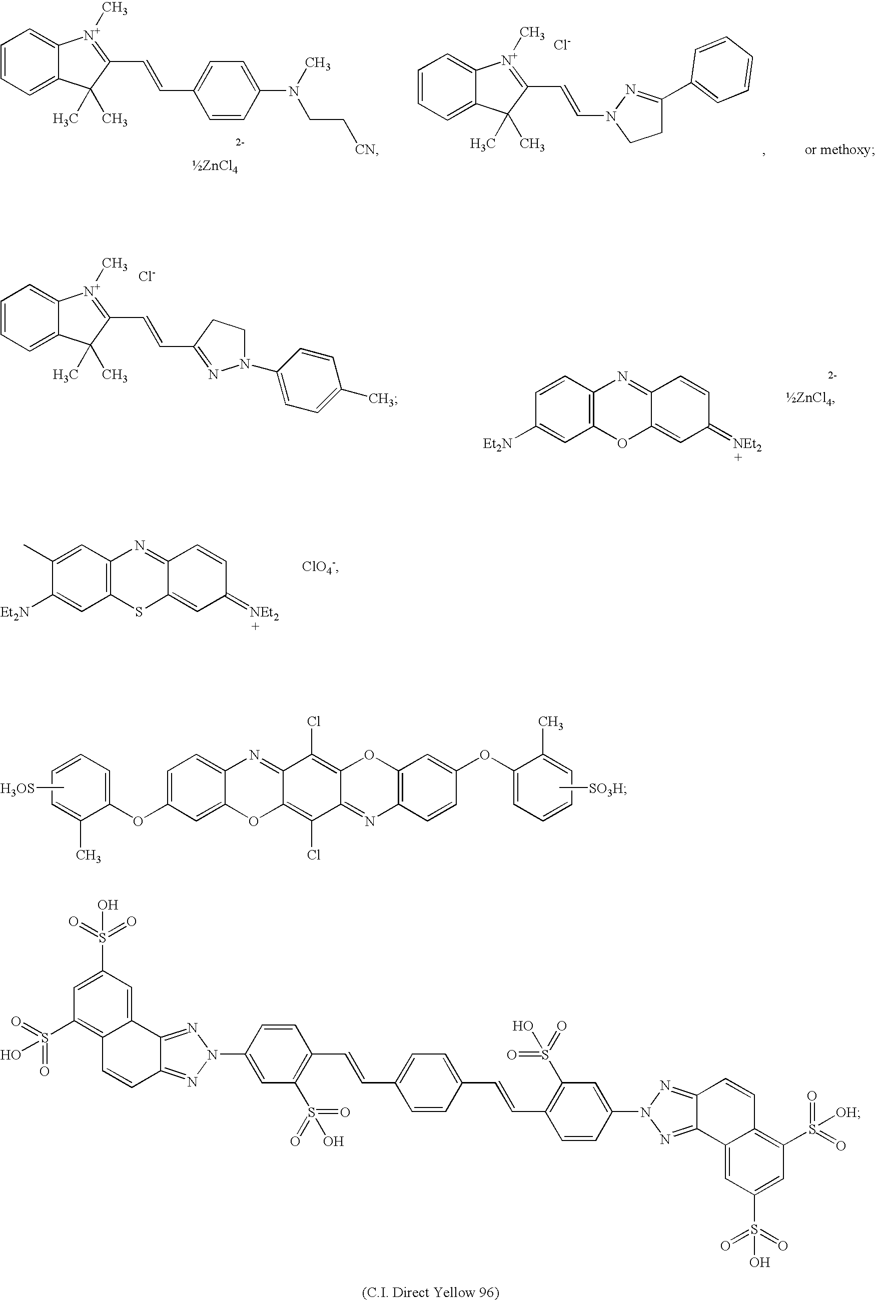 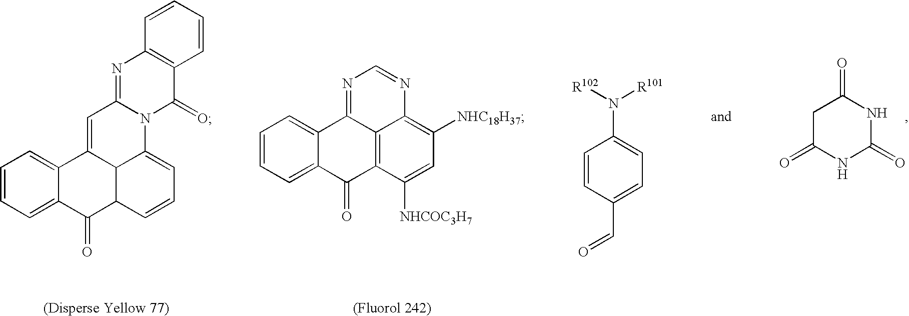
wherein R¹⁰¹ and R¹⁰² are independently hydrogen or C₁-C₁₈ alkyl;

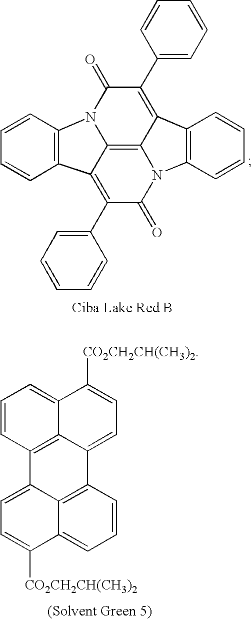

5. A non-porous or porous SiO_{z} flake according to claim 1, wherein the luminescent compound is chemically bonded to the SiO_{z} flake.

6. A non-porous or porous SiO_{z} flake according to claim 5, wherein the luminescent compound is an organic luminescent compound and is chemically bonded to the SiO_{z} flake via a group —X¹—(X²)ₓ₂—X³—: 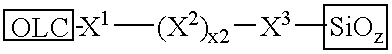
wherein 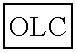
is an organic luminescent compound, x2 is 0, or 1,
X³ is a group —Si(OR¹¹³)₂O—, wherein R¹¹³ is H, or —OSi—,
X² is spacer group,
X¹ is selected from —NR¹¹⁴C(═O)—, —OC(═O)—, —SC(═O)—, —C(R^{114′})═N—NH—, —SO₂—CH₂—CH₂—O—, —SO₂—CH₂—CH₂—S—, —SO₂—CH₂—CH₂—NH—, 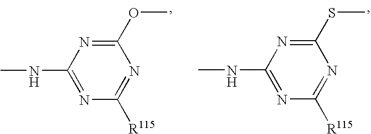
wherein R¹¹⁵ is chloro, substituted amino group, OH, or OR¹¹⁶, wherein R¹¹⁶ is C₁₋₄alkyl; —C(═O)NH—, —S—CH₂—C(═O)—NH—, —O—CH₂—C(═O)—NH—, or —NH—CH₂—C(═O)—NH—, —NH—C(═S)—NH—, —S—C(═S)—NH—, —NH—C(═O)—NH—, —S—C(═O)—NH—, —O—C(═O)—NH—, —NR¹¹⁴—, —S—, or —O—, wherein R¹¹⁴ is hydrogen or C₁₋₈alkyl and R¹¹⁴ is hydrogen or C₁₋₈alkyl.

7. A non-porous or porous SiO_{z} flake according to claim 6, wherein the organic luminescent compound is selected from coumarins, benzocoumarins, xanthenes, benzo[a]xanthenes, benzo[b]xanthenes, benzo[c]xanthenes, phenoxazines, benzo[a]phenoxazines, benzo[b]phenoxazines and benzo[c]phenoxazines, napthalimides, naphtholactams, azlactones, methines, oxazines and thiazines, diketopyrrolopyrroles, perylenes, quinacridones, benzoxanthenes, thio-epindolines, lactamimides, diphenylmaleimides, acetoacetamides, imidazothiazines, benzanthrones, perylenmonoimides, perylenes, phthalimides, benzotriazoles, pyrimidines, pyrazines, triazoles, dibenzofurans and triazines.

8. A non-porous or porous SiO_{z} flake according to claim 5, wherein the luminescent colorant is an inorganic luminescent compound and is chemically bonded to the SiO_{z} flake via a group —X⁴—(X²)ₓ₂—X³—: 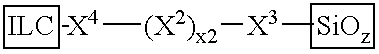
wherein x2 is 0, or 1, 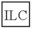
is inorganic luminescent complex compound having a partial structure M-L-, wherein
M is a metal and L is a ligand which is chemically bonded to X⁴, or 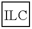
is an inorganic luminescent complex compound having a partial structure 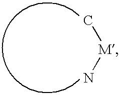
wherein
C—N is a cyclometallated ligand, which is chemically bonded to X⁴, M′ is a metal with an atomic weight of greater than 40,
X³ is a group —Si(OR¹¹³)₂O—, wherein R¹¹³ is H, or —OSi—,
X² is spacer group
X⁴ is selected from —NR¹¹⁴C(═O)—, —OC(═O)—, —SC(═O)—, —C(R^{114′})═N—NH—, —SO₂—CH₂—CH₂—O—, —SO₂—CH₂—CH₂—S—, —SO₂—CH₂—CH₂—NH—, 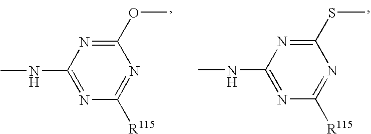
wherein R¹¹⁵ is chloro, substituted amino group, OH, or OR¹¹⁶, wherein R¹¹⁶ is C₁₋₄alkyl, —C(═O)NH—, —S—CH₂—C(═O)—NH—, —O—CH₂—C(═O)—NH—, or —NH—CH₂—C(═O)—NH—, —NH—C(═S)—NH—, —S—C(═S)—N H—, —NH—C(═O)—NH—, —S—C(═O)—NH—, —O—C(═O)—NH—, —NR^{114′}—, —S—, or —O—, wherein R¹¹⁴ is hydrogen or C₁₋₈alkyl and R^{114′} is hydrogen or C₁₋₈alkyl.

9. The porous SiO_{z} flake according to claim 1, wherein the luminescent compound is an inorganic phosphor.

10. The porous SiO_{z} flake according to claim 9, wherein the inorganic phosphor is selected from sulfides, selenides, sulfoselenides, oxysulfides, borates, aluminates, silicates, halophosphates and phosphates, germanates, oxides, arsenates, vanadates, sulfates, tungstates, molybdates and halide phosphors.

11. The porous SiO_{z} flake according to claim 10, wherein the inorganic phosphor is selected from Zn_{1-y}Cd_{y}S (0≦y≦0.3), optionally comprising copper, silver, manganese, gold, rare earths or zinc as an activator; MgS activated with rare earths, CaS activated with rare earths; Y₂O₂S:Eu³⁺, Y₂O₂S:Tb³⁺, Gd₂O₂S:Tb³⁺, Sr₃B₁₂O₂₀F₂:Eu²⁺, Y₃Al₅O₁₂:Ce³⁺, Ce_{0.65}Tb_{0.35}MgAl₁₁O₁₉, BaMg₂Al₁₆O₂₇:Eu²⁺, Y₂Al₃Ga₂O₁₂:Tb³⁺, ZnSiO₄:Mn, Y₂SiO₅:Ce³⁺, 3Ca₃(PO₄)₂.Ca(F, Cl)₂:Sb³⁺, Mn²⁺, (Sr,Mg)₃(PO₄)₂:Sn²⁺, LaPO₄:Ce³⁺, Tb³⁺,Zn₃(PO₄)₂:Mn²⁺, Cd₅Cl(PO₄)₂:Mn²⁺, Sr₃(PO₄)₂.SrCl₂:Eu²⁺, Ba₂P₂O₇:Ti⁴⁺, 3Sr₃(PO₄)₂.SrCl₂:Eu²⁺, Y₂O₃:Eu³⁺, Y₂O₃:Eu³⁺, Tb³⁺, ZnO:Zn, 6MgO.As₂O₅:Mn⁴⁺, YVO₄:Eu³⁺, alkali-metal sulfates activated with Ce³⁺ and optionally manganese, alkaline-earth sulfates activated with Ce³⁺ and optionally manganese; MgWO₄, CaWO₄, alkali-metal halides optionally comprising Eu, Mg, Tl, Ga, or In; CaF₂:Mn, CaF₂:Dy, (Zn, Mg)F₂:Mn²⁺, KMgF₃:Mn²⁺, MgF₂:Mn²⁺, (Zn, Mg)F₂:Mn²⁺, Eu₂(WO₄)₃, LaOCl:Tb³⁺, LaOBr:Tb³⁺ and LaOBr:Ce³⁺.

12. A non-porous or porous SiO_{z} flake according to claim 1, wherein the organic luminescent compound is an optical brightener selected from distyrylbenzenes, distyrylbiphenyls, divinylstilbenes, triazinylaminostilbenes, stilbenyl-2h-triazoles, benzoxazoles, furans, benzo[b]furans, benzimidazoles, 1,3-diphenyl-2-pyrazolines, coumarins, naphthalimides and 1,3,5-triazin-2-yl derivatives.

13. A textile surface coating, printing ink, plastic, cosmetic formulation or, glaze for ceramics and glass comprising a non-porous or porous SiO_{z} flake according to claim 1.

14. A composition comprising a high molecular weight organic material and from 0.01 to 80% by weight, based on the high molecular weight organic material, of the luminescent SiO_{z} flakes according to claim 1.

15. A cosmetic preparation or formulation, comprising from 0.0001 to 90% by weight of the luminescent SiO_{z} flakes, according to claim 1 and from 10 to 99.9999% of a cosmetically suitable carrier material, based on the total weight of the cosmetic preparation or formulation.

16. A substrate material, comprising a porous SiO_{z} film, which comprises a luminescent organic or inorganic compound, or composition according to claim 1.

17. A non-porous or porous SiO_{z} flake according to claim 6, wherein the spacer group X² is
—(CHR′)p-,
—{(CHR′)q-O—(CHR′)r}s-,
—{(CHR′)q-S—(CHR′)r}-,
—{(CHR′)q-NR′—(CHR′)r}s-,
—{(CHR′)q-Si(R′)₂—(CHR′)r}s-,
—{(CHR′)q-(CH═CH)—(CHR′)r}s-,
—{(CHR′)q-Ar—(CHR′)r}-,
—{(CHR′)q-CO—NR′—(CHR′)r}s- or
—{(CHR′)q-CO—Ar—NR′—(CHR′)r}s-, wherein R′ is hydrogen, C₁₋₄alkyl or aryl which may be optionally substituted with sulphonate, Ar is phenylene optionally substituted with sulphonate, p is 1-20, q is 1-10, r is 1-10 and s is 1-5.

18. A non-porous or porous SiO_{z} flake according to claim 8, wherein M is a rare earth metal.

19. A non-porous or porous SiO_{z} flake according to claim 8, wherein the spacer group X² is
—(CHR′)p-,
—{(CHR′)q-O—(CHR′)r}s-,
—{(CHR′)q-S—(CHR′)r}-,
—{(CHR′)q-NR′—(CHR′)r}s-,
—{(CHR′)q-Si(R′)₂—(CHR′)r}s-,
—{(CHR′)q-(CH═CH)—(CHR′)r}s-,
—{(CHR′)q-Ar—(CHR′)r}-,
—{(CHR′)q-CO—NR′—(CHR′)r}s- or
—{(CHR′)q-CO—Ar—NR′—(CHR′)r}s-, wherein R′ is hydrogen, C₁₋₄alkyl or aryl which may be optionally substituted with sulphonate, Ar is phenylene optionally substituted with sulphonate, p is 1-20, q is 1-10, r is 1-10 and s is 1-5.
